(19) United States
(12) Patent Application Publication
(10) Pub. No.: US 2023/0216039 A1
(43) Pub. Date: Jul. 6, 2023

(54) A CLASS OF ARTIFICIAL SEI LAYERS FOR STABILIZING LITHIUM DEPOSITION IN LITHIUM BATTERIES AND RELATED METHODS

(71) Applicant: Board of Regents, The University of Texas System, Austin, TX (US)

(72) Inventors: Arumugam MANTHIRAM, Austin, TX (US); Sanjay NANDA, Austin, TX (US); Amruth BHARGAV, III, Austin, TX (US)

(21) Appl. No.: 17/912,680

(22) PCT Filed: Mar. 18, 2021
(86) PCT No.: PCT/US2021/022971

§ 371 Date: Sep. 19, 2022

Related U.S. Application Data
(60) Provisional application No. 62/992,069, filed on Mar. 19, 2020.

(51) Int. Cl. H01M 4/38; H01M 4/62; H01M 4/04; H01M 50/414; H01M 50/449

(52) U.S. Cl. CPC H01M 4/381; H01M 4/621; H01M 4/0445; H01M 50/414; H01M 50/449; H01M 2004/027

(57) ABSTRACT

Described herein are electrodes, electrochemical cells, methods of making electrodes and methods of making electro-chemical cells. The electrodes described herein have an interface layer or material that can stabilize reversible alkali metal deposition. The interface material may correspond to or be a solid-electrolyte interphase that can allow alkali metal ions to transmit through and be deposited below the interface material. The interface material can prevent dendrite formation and/or decomposition of the electrolyte, enabling use of lithium metal safely in a secondary (i.e., rechargeable) electrochemical cell. The interface material may comprise a combination of one or more metals, one or more chalcogens, and one or more other elements or organic functional groups.

### CROSS REFERENCE TO RELATED APPLICATIONS

This application claims the benefit of and priority to U.S. Provisional Application No. 62/992,069, filed on Mar. 19, 2020, which is hereby incorporated by reference in its entirety.

### STATEMENT REGARDING FEDERALLY SPONSORED RESEARCH OR DEVELOPMENT

This invention was made with government support under Grant No. DE-SC0005397 awarded by the Department of Energy. The government has certain rights in the invention.

### FIELD

This invention is in the field of lithium batteries. This invention relates generally to techniques for stabilizing lithium metal anodes by creating an artificial solid-electrolyte interphase material over the lithium metal, associated electrolytes, and electrochemical cells.

### BACKGROUND

Batteries including lithium metal as an anode are generally regarded as not rechargeable. Decomposition of liquid electrolytes can occur during recharging, which may damage or degrade the cells. Additionally, dendrites can form on the lithium anode, risking short-circuiting of the battery.

### SUMMARY

The present disclosure relates to electrodes and electrochemical cells with protective components allowing use of lithium metal (or other alkali metal) as an anode, even in secondary (i.e., rechargeable) batteries. The protective component may correspond to a layer of an interface material over or coating an alkali metal anode, such as an artificial solid-electrolyte interphase (SEI) material.

In an aspect, the present disclosure provides electrodes, which may be useful as an anode of an electrochemical cell. For example, an electrode of this aspect comprises an alkali metal or a substrate for alkali metal deposition; and an interface material on a surface of the alkali metal or the substrate. The alkali metal may be lithium, sodium, potassium, cesium, etc. The interface material may comprise a metal or combination of metals; a chalcogen or any combination of chalcogens; and one or more elements, one or more organic functional groups, or a combination of one or more elements and one or more organic functional groups.

The interface material may comprise, correspond to, or act as an artificial solid-electrolyte interphase. The interface material may have a chemical formula of AₓM_{y}Q_{z}. A may correspond to a metal or combination of metals. Q may correspond to a chalcogen or any combination of chalcogens. M may correspond to one or more elements, one or more organic functional groups, or the combination of one or more elements and one or more organic functional groups. The values for x, y, and z may represent the relative amounts of A, M, and Q, respectively in the interface material and may be from 0 to 1 or between 0 and 1. The chalcogen (Q) or combination of chalcogens may be one or a combination of sulfur, selenium, or tellurium. The metal (A) may be an alkali metal, such as lithium, sodium, potassium, or cesium. The one or more elements, the one or more organic functional groups, or the combination of one or more elements and one or more organic functional groups (M) may correspond to an element less electronegative than the chalcogen or the combination of chalcogens. The one or more elements, the one or more organic functional groups, or the combination of one or more elements and one or more organic functional groups (M) may correspond to an element having a similar electronegativity to the chalcogen or the combination of chalcogens. Useful examples include, but are not limited to, one or a combination of tellurium, phosphorus, arsenic, antimony, bismuth, carbon, germanium, tin, lead, gallium, indium, molybdenum, tungsten, titanium, vanadium, copper, silver, gold, zinc, or cadmium. In some examples, the interface material comprises Li₂TeS₃, Li₃SbS₄, Li₂CS₃, LiₓMo_{y}S_{z}, or LiₓW_{y}S_{z}.

In another aspect, electrochemical cells are provided. The electrochemical cells described herein may be primary and/or secondary electrochemical cells. An example electrochemical cell of this aspect comprises a positive electrode, such as a positive electrode that can reversibly store and release alkali metal ions; an electrolyte; and a negative electrode. The negative electrode may comprise the electrodes described above. For example, the negative electrode may comprise an alkali metal or a substrate for alkali metal deposition; and an interface material on a surface of the alkali metal or the substrate. The interface material may correspond to that noted above and may comprise a metal or combination of metals; a chalcogen or any combination of chalcogens; and one or more elements, one or more organic functional groups, or a combination of one or more elements and one or more organic functional groups.

Any suitable positive electrode useful with alkali metal or alkali metal ion batteries may be used with the electrochemical cells described herein. For example, the positive electrode may be a conversion-based or insertion-based cathode. Optionally, the positive electrode comprises an oxygen-based electroactive material, a sulfur-based electroactive material, a selenium-based electroactive material, a layered-oxide cathode material, LCO (lithium cobalt oxide), NMC (lithium nickel manganese cobalt oxide), NCA (lithium nickel cobalt aluminum oxide), a spinel-based cathode material, LMO (lithium manganese oxide), LNMO (lithium manganese nickel oxide), a polyanion-based cathode material, or LFP (lithium iron phosphate).

Any suitable electrolyte used with alkali metal or alkali metal ion batteries may be used with the electrochemical cells described herein. For example, the electrolyte may be a solid or liquid or mixed-phase material that conducts alkali metal ions and blocks passage of electrons.

Optionally, the interface material is formed in situ after assembly of the electrochemical cell. Optionally, the interface material is formed in situ during operation when an electric field is applied between the positive electrode and the negative electrode. Optionally, the interface material is formed in situ during one or more charging or discharging operations, such as during an initial charging or discharging operation, or within a few or several charging or discharging operations, such as within 1, 2, 3, 4, or 5 charging and/or discharging operations.

In embodiments, the interface material may be fabricated prior to assembly of the electrochemical cell. As an example, in some cases, the interface material may be fabricated on a negative electrode prior to assembly, such as ex situ by a deposition or coating process on an alkali metal electrode or a negative electrode current collector. For example, a solution-based coating method can be used, such as a drop-casting technique in which a solution of a poly-chalcogen-sulfide, like a polytellurosulfide, or a suitable precursor, is deposited onto an alkali metal or current collector foil to form the interface material thereon. As another example, a vapor deposition coating method can be used, such as where a layer of Li₂TeS₃ or a precursor material, such as TeS₂/Li₂Te, is deposited by chemical vapor deposition onto an alkali metal or current collector foil to form the interface material thereon. As another example, a vapor deposition coating method can be used, such as where a layer of Li₃SbS₄ or a precursor material, such as Sb₂S₅, is deposited by chemical vapor deposition onto an alkali metal or current collector foil to form the interface material thereon

Such an ex situ prepared negative electrode with an interface material thereon can then be used in any suitable electrochemical cell system with any desired cathode chemistry. Alternatively, in some cases, the interface material may be fabricated on a negative electrode prior to assembly through in situ fabrication in another electrochemical cell, and then that negative electrode with the interface material thereon can be used in the assembly of a different electrochemical cell, optionally using a different chemistry. For example, the interface material may be generated in an alkali metal-sulfur battery system (e.g., with a sulfur cathode) and then the alkali metal negative electrode with a coating layer of the interface material thereon removed from the alkali metal-sulfur battery system and incorporated into a different electrochemical cell incorporating an alkali metal-metal oxide cathode. In this way, the negative electrode can have the layer of interface material pre-fabricated thereon at the time of assembly of the different electrochemical cell.

In a further aspect, methods are described herein, such as methods of producing an interface material, such as on a negative electrode of an electrochemical cell. An example method of this aspect comprises introducing an additive into a component of the electrochemical cell during assembly; and forming the interface material in situ after assembly of the electrochemical cell. The interface material may again correspond to those described above and may comprise, for example, a metal or combination of metals; a chalcogen or any combination of chalcogens; and one or more elements, one or more organic functional groups, or a combination of one or more elements and one or more organic functional groups. The electrochemical cell or the anode may be based on alkali metal plating and stripping, for example.

Optionally, the additive may be introduced into or included in the electrolyte. For example, the interface material may be formed in situ by partial or complete reduction of one or more components of the electrolyte, including the additive, on a surface of the negative electrode. As an example, the additive may comprise a chalcogen-based composition dissolved or present in the electrolyte. Example additives include, but are not limited to organotellurium additives, such as diphenyl ditelluride, polytellurosulfide species, thiomolybdate species, or thiotungstate species.

Optionally, the additive may be introduced into or included in the positive electrode. For example, the interface material may be formed in situ by reaction of the additive with one or more electrolyte components to form a secondary electrolyte component, and partial or complete reduction of the secondary electrolyte component on a surface of the negative electrode. As an example, the additive may comprise a chalcogen-based composition dispersed or present in the positive electrode. Example additives include, but are not limited to, Te, Li₂CS₃, (NH₄)₂MoS₄, or (NH₄)₂WS₄.

Optionally, the additive may be introduced onto the polymer separator as a coating. For example, the interface material may be formed in situ by reaction of the separator coating with one or more electrolyte components to form a secondary electrolyte component; and partial or complete reduction of the secondary electrolyte component on a surface of the negative electrode. As an example, the additive may comprise a chalcogen-based coating on the separator, such as a tellurium coating.

Optionally, the additive may be introduced into or included in the negative electrode or in the negative electrode current collector. For example, the interface material may be formed in situ by reaction of the additive with one or more electrolyte components to form a secondary electrolyte component, and partial or complete reduction of the secondary electrolyte component on a surface of the negative electrode. In some cases, the interface material may be formed in situ by direct reaction or reduction of the additive on a surface of the negative electrode. As an example, the additive may comprise a chalcogen-based coating on the negative electrode or negative electrode current collector, such as a tellurium coating.

In embodiments, the electrochemical cell comprises a positive electrode comprising a sulfur-based active material and the additive, an organic liquid electrolyte, the negative electrode. In some examples, the additive is tellurium or a tellurium composition, such a tellurium sulfide compound. In some examples, the additive is molybdenum or a molybdenum composition, such as a thiomolybdate, such as (NH₄)₂MoS₄. In some examples, the additive is tungsten or a tungsten composition, such as a thiotungstate, such as (NH₄)₂WS₄. In some examples, the negative electrode corresponds to a lithium plating and stripping electrode. In some examples, the interface material comprises Li₂TeS₃, Li₃SbS₄, Li₂CS₃, LiₓMo_{y}S_{z}, or LiₓW_{y}S_{z}, where x, y, and z are each independently between 0 and 1.

Optionally, methods of this aspect may further include disassembling the electrochemical cell, at least in part, to remove or separate the negative electrode with the interface material thereon and incorporating the negative electrode with the interface material thereon into a different electrochemical cell. In this way, the negative electrode in the different electrochemical cell can have a coating or layer of the interface material thereon at the time of assembly and incorporation into the different electrochemical cell. This may also allow the different electrochemical cell to use a different chemistry, which may be incompatible with in situ formation of the interface material or may not include components or additives permitting formation of the interface material in situ.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a schematic cross-sectional illustration of an example electrode in accordance with some embodiments.

FIG. 2A and FIG. 2B provide a schematic cross-sectional illustrations of another example electrode in accordance with some embodiments.

FIG. 3 provide a schematic cross-sectional illustrations of an example electrochemical cell in accordance with some embodiments.

FIG. 4 provides an overview of an example method of making a protective interface on an anode of an electrochemical cell in accordance with some embodiments.

FIG. 5A provides a schematic illustration of an anode-free full-cell. FIG. 5B provides data showing the electrochemical performance of different cells. FIG. 5C provides XPS data of different cells.

FIG. 6A provides a photograph showing Color change of Li₂S₆ when reacted with excess Te. FIG. 6B provides ToF-SIMS for reaction products of Li₂S₆ with excess Te. FIG. 6C provides XPS data showing formation of Li₂TeS₃ when a polytellurosulfide solution reacts with Li metal.

FIG. 6D provides a schematic illustration of dissolution of Te by polysulfides, migration to the anode side, and formation of lithium thiotellurate (Li₂TeS₃) on deposited lithium.

FIG. 7A and FIG. 7B provide data showing electrochemical performance of different cells. FIG. 7C provides charge/discharge profiles different cells. FIG. 7D provides cyclic voltammograms (CVs) of different cells.

FIG. 8A provides XPS data measurements of the deposited lithium in an anode-free cell. FIG. 8B provides ToF-SIMS data. FIG. 8C provides a schematic illustration of a bilayer tellurized and sulfurized lithium SEI structure.

FIG. 9A provides SEM images showing smooth, dense, and planar deposition of lithium with Te additive, with lower porosity and smaller surface area. FIG. 9B provides SIMS data.

FIG. 10A provides a photograph of an example pouch cell. FIG. 10B provides data showing electrochemical performance of the pouch cell. FIG. 10C provides data showing XPS analysis of harvested lithium from lean electrolyte coin cells shows the presence of Li₂TeS₃ in the lithium SEI.

FIG. 11 provides data showing electrochemical performance of an anode-free cell.

FIG. 12 provides data showing UV-Vis absorption spectra for 0.02 M Li₂S₆ in DOL/DME (1:1) solution before and after excess tellurium added.

FIG. 13 provides XPS data measurements for a lithium-metal foil exposed to the [Li₂S₆+Te] polytellurosulfide solution and then washed with blank ether solvent and peak analysis data.

FIG. 14 provides XPS data for a Li₂S/CNT cathodes without and with 0.1 Te additive.

FIG. 15 provides CVs of anode-free cells at different scan rates.

FIG. 16 provides charge/discharge profiles of different anode-free cells for the first and second cycles.

FIG. 17 provides data showing capacity vs cycle number for Li∥Li₂S half-cells at C/5 rate.

FIG. 18 provides data showing the effect of initial cycling conditions on the performance of an anode-free cell.

FIG. 19A, FIG. 19B, and FIG. 19C provide CVs for Li∥Te half-cells with a bare tellurium/CNT cathode (without any Li₂S) in 1 M LiTFSI+0.1 M LiNO₃ in DOL/DME (1:1) electrolyte, and XPS of the lithium surface after two scans each at 0.05 and 0.1 mV s⁻¹.

FIG. 20 provides XPS measurements for deposited lithium in an anode-free cell and peak analysis data.

FIG. 21 provides ToF-SIMS data for of deposited lithium in an anode-free cell showing two different profiles for the TeS⁻ fragment (from Li₂TeS₃) and the LiTe⁻ fragment (from Li₂Te/Li₂Te₂).

FIG. 22 provides data showing capacity vs. cycle number for different cell configurations.

FIG. 23A provides data showing voltage profiles for plating and stripping lithium in different cells. FIG. 23B provides Nyquist plots for different cells.

FIG. 24 provides data showing depth profiles obtained with ToF-SIMS for the SO⁻, F₂⁻, and CH⁻ fragments in the deposited lithium of anode-free cells after 30 cycles.

FIG. 25 provides data showing charge-discharge profiles for large-area Li—S pouch cells, with and without 0.1Te additive.

FIG. 26 provides data showing capacity versus cycle number for lean-electrolyte Li—S coin cells, with and without 0.1Te additive and associated XPS data.

FIG. 27 provides data showing capacity versus cycle number for anode-free Li—S cells with and without ammonium tetrathiomolybdate or ammonium tetrathiotungstate cathode additives.

### DETAILED DESCRIPTION

Described herein are electrodes, electrochemical cells, methods of making electrodes, and methods of making electrochemical cells. The electrodes described herein have an interface layer or material that can stabilize reversible alkali metal deposition. The interface material may correspond to or be a solid-electrolyte interphase that can allow alkali metal ions to transmit through and be deposited below the interface material. The interface material can prevent dendrite formation and/or decomposition of the electrolyte at the electrode, enabling use of lithium metal safely in a secondary (e.g., rechargeable) electrochemical cell (e.g., as an anode). The interface material may comprise a combination of one or more metals, one or more chalcogens, and one or more other elements or organic functional groups. An example interface material may comprise lithium thiotellurate (Li₂TeS₃) and/or lithium telluride (Li₂Te). Other examples include, but are not limited to Li₃SbS₄, Li₂CS₃, LiₓMo_{y}S_{z}, or LiₓW_{y}S_{z}, where x, y, and z are independently between 0 and 1. The interface material may also allow electrochemical cells to exhibit low- or no-excess lithium thereby providing weight advantages. In some cases, such a configuration can limit the mass of the anode to only that which is electrochemically useful. For example, “anode-less” electrochemical cells are described which may include no or zero anode active material (e.g., zero excess anode active material), such as when fully discharged. Some advantages of these anode-less electrochemical cells may include improvements in gravimetric energy density or volumetric energy density, such as when compared to conventional cells including an anode, such as with a typical or excess amount of active material. Another advantage of an anode-less electrochemical cells is that such a cell has no self-discharge, since the cell can be assembled or correspond to a discharged state. Further, anode-less electrochemical cells can be advantageous since metallic lithium may not be used generally and, particularly, this configuration may also preclude the use and handling of thin lithium foils.

The interface material may be particularly useful for sulfur-based electrochemical cells, such as a lithium-sulfur electrochemical cell. Sulfur-based electrochemical cells are particularly advantageous because the interface material can be easily prepared by including additives in the sulfur (cathode) component of the electrochemical cell and then preparing the interface material in situ during operation or cycling of the electrochemical cell.

Although the present description may describe use of the interface material with sulfur-based electrochemical cells like lithium-sulfur electrochemical cells, the interface material is generally useful with any alkali metal electrochemical cell and is not specific to sulfur cathode cells. It will be appreciated that, although the present description describes preparation of a lithium anode with a protective coating of the interface material, alkali metal anodes with a protective coating of the interface material can be prepared and used in the same way as lithium-based systems by substituting the other alkali metal (e.g., sodium, potassium, or cesium, etc.) for lithium. It will further be appreciated that electrodes including a protective coating of the interface material can be used in other alkali metal electrochemical cell systems beyond sulfur-based cathode systems (e.g., Li₂S), such as any conventional alkali metal-ion (e.g., Li-ion) cathode system, such as those comprising an oxygen-based electroactive material, a selenium-based electroactive material, a layered-oxide cathode material, LCO (lithium cobalt oxide), NMC (lithium nickel manganese cobalt oxide), NCA (lithium nickel cobalt aluminum oxide), a spinel-based cathode material, LMO (lithium manganese oxide), LNMO (lithium manganese nickel oxide), a polyanion-based cathode material (e.g., phosphate-, sulfate-, silicate-, borate-, etc. based cathode materials or combinations thereof), or LFP (lithium iron phosphate).

Without wishing to be bound by any theory, the interface material may be generated upon reaction or deposition of certain materials at the anode interface. For example, inclusion of tellurium as an additive in a sulfur electrode of an electrochemical cell may allow for generation of an interface material comprising tellurium and sulfur during operation or cycling of the electrochemical cell. As will be appreciated, polysulfide shuttles can transfer material from the cathode to the anode in a sulfur-based battery system. This aspect can be exploited to intentionally create an interface material at the anode where an additive material from the cathode is shuttled to the anode by way of polysulfides.

The interface material may have a chemical formula of AₓM_{y}Q_{z}, where A is a metal or a combination of metals, M is one or more elements or one or more organic functional groups or a combination of one or more elements and one or more functional groups, and Q is a chalcogen or a combination of chalcogens. Each of x, y, and z can represent a relative molar amount of A, M, and Q, respectively and can vary from 0 to 1. Chalcogen Q may be one or a combination of sulfur, selenium, or tellurium. Component M can be or comprise an element or elements less electronegative than the chalcogen Q, or in some cases M can be or comprise an element or elements having a similar electronegativity to the chalcogen Q. Examples of component M can comprise or include, though are not limited to, tellurium, phosphorus, arsenic, antimony, bismuth, carbon, germanium, tin, lead, gallium, indium, molybdenum, tungsten, titanium, vanadium, copper, silver, gold, zinc, or cadmium. Component A may be an alkali metal, such as lithium, sodium, potassium, or cesium.

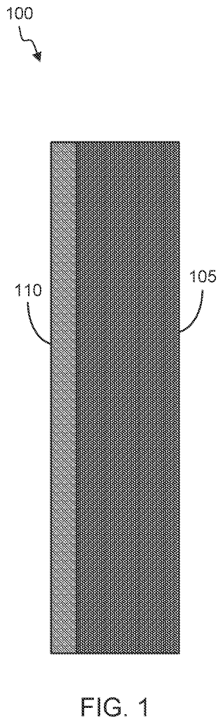

FIG. 1 provides a schematic illustration of an example electrode 100 comprising an alkali metal 105 and an interface material 110 on the surface of the alkali metal 105. Electrode 100 may optionally include a current collector (e.g., a copper current collector), but this is not depicted in FIG. 1. The interface material 110 may coat all or only a portion of the alkali metal 105. In some cases, the interface material 110 may coat portions of the alkali metal 105 that are exposed to or in contact with an electrolyte.

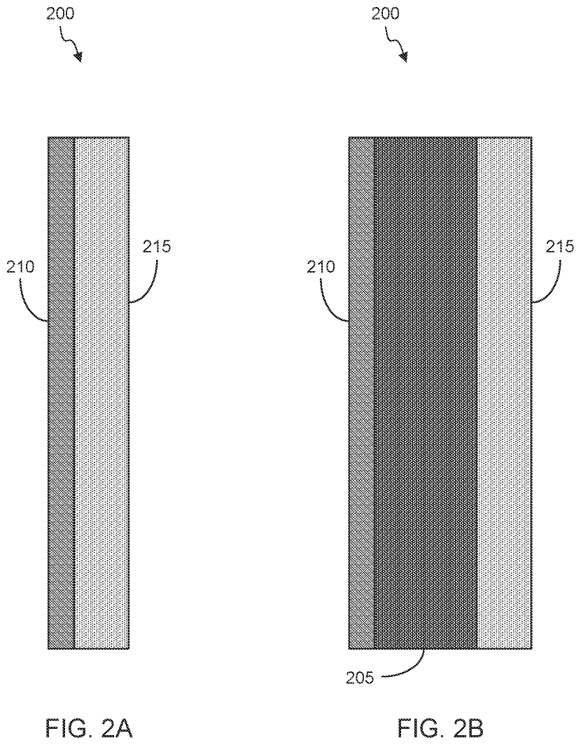

As noted above, “anode-less” electrochemical cells are described, which may correspond to an electrode with a substrate for alkali metal deposition, over which an interface material can be positioned. During operation of such an electrochemical cell, alkali metal may be deposited on the substrate and/or beneath the interface material. FIG. 2A provides a schematic illustration of an example electrode 200 comprising a substrate 215 for alkali metal deposition. During operation, alkali metal ions can transmit through the interface material 210 and be deposited as a region or layer of anode active material comprising an alkali metal 205. FIG. 2B shows the configuration where the alkali metal 205 is arranged between the substrate 215 and the interface material 210. Examples of materials for substrates 215 for alkali metal deposition may include materials used for a current collector, such as copper. In some cases, other conductive materials, such as graphite or carbon may be used as substrate 215.

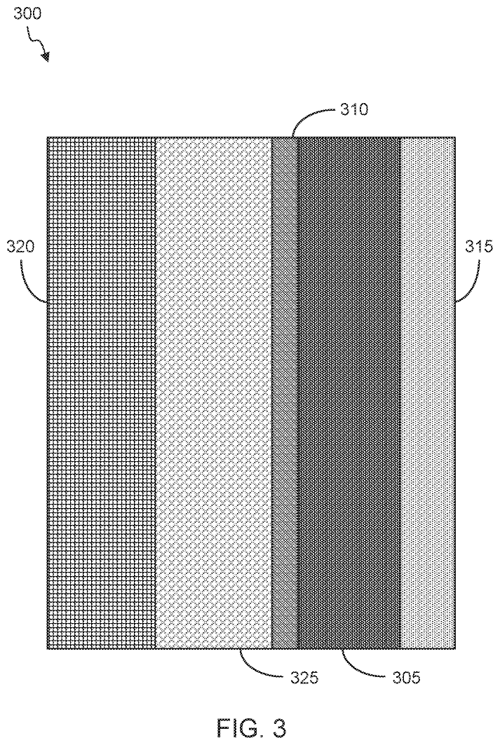

The electrodes described above and depicted in FIG. 1, FIG. 2A, and FIG. 2B can be incorporated into an electrochemical cell. FIG. 3 provides an example of an electrochemical cell 300. Electrochemical cell 300 includes an anode comprising an alkali metal 305, an interface material 310, and a substrate 315, such as for deposition of alkali metal 305. Electrochemical cell 300 further comprises a cathode 320 and a separator 325. Separator 325 may comprise or include an electrolyte, such as a liquid electrolyte, to permit transmission of ions between the alkali metal 305 and the cathode 320. Cathode 320 may be, correspond to, or comprise any suitable alkali metal cathode, such as may be used in an alkali metal ion cell. Cathode 320 may optionally comprise a current collector, such as a nickel or aluminum current collector. Cathode 320 may also include conductive additives, binders, or the like. It will be appreciated that the components of electrochemical cell 300 illustrated in in FIG. 3 are not shown to scale. Electrochemical cell 300 depicted in FIG. 3 may correspond to an at least partly charged electrochemical cell configuration.

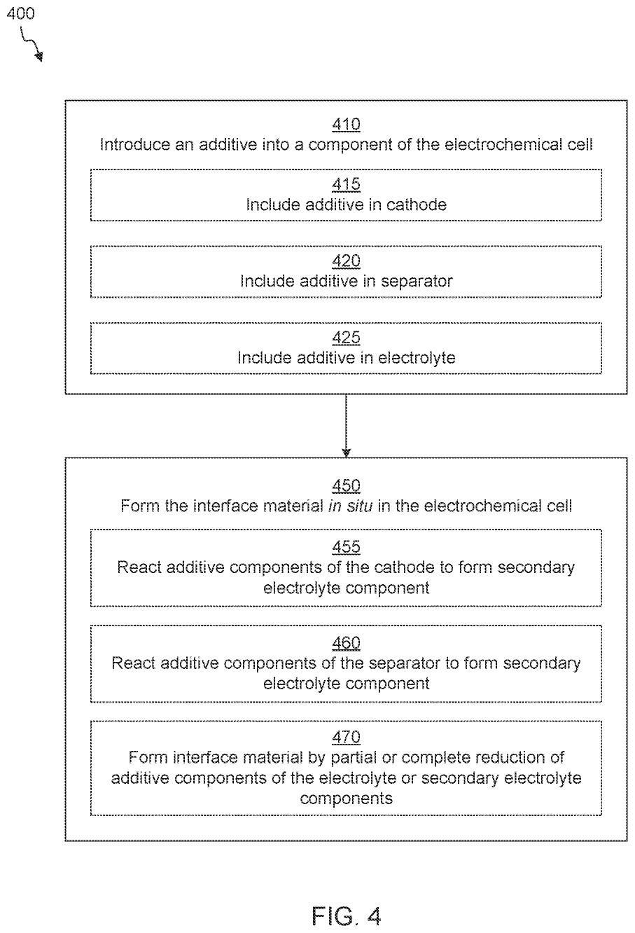

FIG. 4 provides an overview of an example method 400 for producing an interface material on a negative electrode of an electrochemical cell. At block 410, an additive is included in a component of the electrochemical cell, such as at the time of assembly or construction of the electrochemical cell. The additive may optionally be included in the cathode, as indicated at block 415. For example, a chalcogen may be included as a component, additive, or, dopant in the active material of the cathode. The additive may optionally be included in the separator, as indicated at block 420. For example, a coating may be provided on the separator, such as a coating comprising a chalcogen. The additive may optionally be included in the electrolyte, as indicated at block 425.

At block 430, the interface material is formed in situ after assembly of the electrochemical cell. For example, as indicated at block 435, the interface material may optionally be formed by reacting the additive, included in the cathode, with one or more electrolyte components to form a secondary or intermediate electrolyte component, which can then be partially or completely reduced on or at a surface of the negative electrode or a component thereof, as indicated at block 470. As indicated at block 440, the interface material may optionally be formed by reacting the additive, included in the separator, with one or more electrolyte components to form a secondary or intermediate electrolyte component, which can then be partially or completely reduced on or at a surface of the negative electrode or a component thereof, as indicated at block 470. If an additive is included in the electrolyte, the interface material may optionally be formed partial or complete reduction on or at a surface of the negative electrode or a component thereof, as indicated at block 470.

In some cases, the interface material can be formed on the negative electrode prior to assembly of the electrochemical cell. For example, the above described methods and techniques can be used to prepare the interface material on a negative electrode, such as in situ in an electrochemical cell, with the electrochemical cell then disassembled to use the negative electrode in another electrochemical cell. Such a configuration may be useful to allow preparing the interface material on the negative electrode, such as in an alkali metal-sulfur electrochemical cell system, and then allowing the negative electrode with the interface material to be used in another electrochemical cell chemistry (e.g., with an alkali metal cobalt oxide type cathode or other non-sulfur-based cathode).

In other cases, the interface material on the negative electrode can be formed using a solution coating technique, which may be performed ex situ of any electrochemical cell. For example, a negative electrode comprising a lithium metal and/or copper foil current collector can receive a coating of a Li₂TeS₃ interface material by subjecting the negative electrode to a solution-based technique in which a polytellurosulfide solution is drop-cast onto the negative electrode. Other similar solution-based coating techniques may be used, such as roll-to-roll coating techniques, immersion coating techniques, or the like. In some cases, a voltage may be applied between the negative electrode and a reference electrode in contact with the solution to facilitate reaction of the polytellurosulfide in the solution to form the interface material on the negative electrode.

In other cases, the interface material on the negative electrode can be formed using a vapor deposition technique, which may be performed ex situ of any electrochemical cell. For example, a negative electrode comprising a lithium metal and/or copper foil current collector can receive a coating of a Li₂TeS₃ interface material by subjecting the negative electrode to chemical vapor deposition of Li₂TeS₃ or a precursor, such as TeS₂/Li₂Te. As another example, a negative electrode comprising a lithium metal and/or copper foil current collector can receive a coating of a Li₃SbS₄ interface material by subjecting the negative electrode to chemical vapor deposition of Li₃SbS₄ or a precursor, such as Sb₂S₅.

The invention may be further understood by the following non-limiting examples.

### Example 1: Anode-Free, Lean-Electrolyte Lithium-Sulfur Batteries Enabled by Tellurium-Stabilized Lithium Deposition

For lithium-sulfur batteries to achieve their promising energy density, it is valuable to stabilize lithium deposition and improve cyclability while reducing excess lithium and electrolyte. This example describes introducing tellurium into the Li—S system as a cathode additive to significantly improve the reversibility of lithium plating/stripping by forming a tellurized sulfide-rich SEI layer on the lithium surface. A remarkable improvement in cyclability is demonstrated in anode-free full-cells with limited lithium inventory and large-area Li—S pouch cells under lean electrolyte conditions. Tellurium reacts with polysulfides to generate soluble polytellurosulfides that migrate to the anode side and form stabilizing lithium thiotellurate and lithium telluride in situ as SEI components. A significant reduction in electrolyte decomposition on the lithium surface is also engendered. This work establishes engineering a stable sulfide-rich SEI layer as a viable strategy for stabilizing lithium deposition and preserving electrochemical performance under limited lithium and limited electrolyte conditions as a robust evaluation framework for realizing practically viable Li—S batteries.

The lithium/sulfur couple holds tremendous potential for enabling the next generation of high-energy density rechargeable batteries, combining the large gravimetric capacities of sulfur (1,675 mA h g⁻¹) and lithium (3,861 mA h g⁻¹). While there has been substantial progress towards solving the numerous issues with sulfur cathodes, a large excess of lithium metal and liquid electrolyte may still be useful for enabling long cycle life. A typical Li—S cell with a 4 mg cm⁻² sulfur cathode and 0.75 mm thick lithium-metal foil anode may have a lithium to sulfur (Li/S) capacity ratio of 20 or even higher. The electrolyte to sulfur (E/S) ratio in such a cell might also exceed 20 μl mg⁻¹ of sulfur. These unrealistic values, representative of literature, can lead to overstated electrochemical performance and compromise system-level energy density. Reducing excess lithium and electrolyte while maintaining reasonable capacities and cyclability is useful to Li—S batteries achieving commercial viability.

These challenges may originate with the intrinsically low Coulombic efficiencies of lithium-metal anode. The low reduction potential of lithium (−3.04 V vs SHE) can cause the electrolyte to undergo irreversible decomposition on the lithium surface to form a solid-electrolyte interphase (SEI). This can be severely exacerbated by the high surface area of lithium undergoing mossy deposition mechanisms under practical current regimes. Combined with the formation of electrochemically inaccessible or “dead” lithium, these side reactions can lead to rapid depletion of the available electrolyte supply and lithium inventory. Employing a large excess of lithium and electrolyte can becomes useful to compensate for these losses. The consequent tradeoff between energy density and cyclability can be addressed by improving the reversibility of lithium-metal anode. In Li—S batteries, the presence of soluble and highly reactive polysulfide intermediates in the ether-based electrolyte can acutely impact lithium deposition and render its characteristics fundamentally distinct from other systems. This may necessitate bold new strategies towards improving lithium deposition in Li—S batteries that account for their unique chemistry and ensure compatibility with polysulfide species. Stabilized lithium deposition can also help substantially mitigate the safety concerns associated with lithium dendrites causing internal shorting and catastrophic failure of the battery.

This example demonstrates that introducing elemental tellurium)(Te⁰ as an additive in the sulfur/Li₂S cathode leads to a dramatic improvement in the reversibility of the lithium-metal anode. Both anode-free full-cells (limited lithium) and large-area pouch cells (limited electrolyte) show significant improvement in cyclability. Te⁰ is solubilized by polysulfides to generate polytellurosulfide species (Li₂TeₓS_{y}) that migrate to the anode side. Their reduction on the deposited lithium helps form a novel bilayer SEI structure in situ, comprising lithium thiotellurate (Li₂TeS₃) and lithium telluride (Li₂Te). Compared with Li₂S, which is the corresponding SEI component in a control system, the tellurium-containing SEI species confer considerable advantages for stabilizing lithium deposition. This example opens a new paradigm for addressing the challenge of improving the reversibility of lithium-metal anodes in Li—S batteries and demonstrates a viable approach towards eliminating excess lithium and electrolyte while maintaining cyclability.

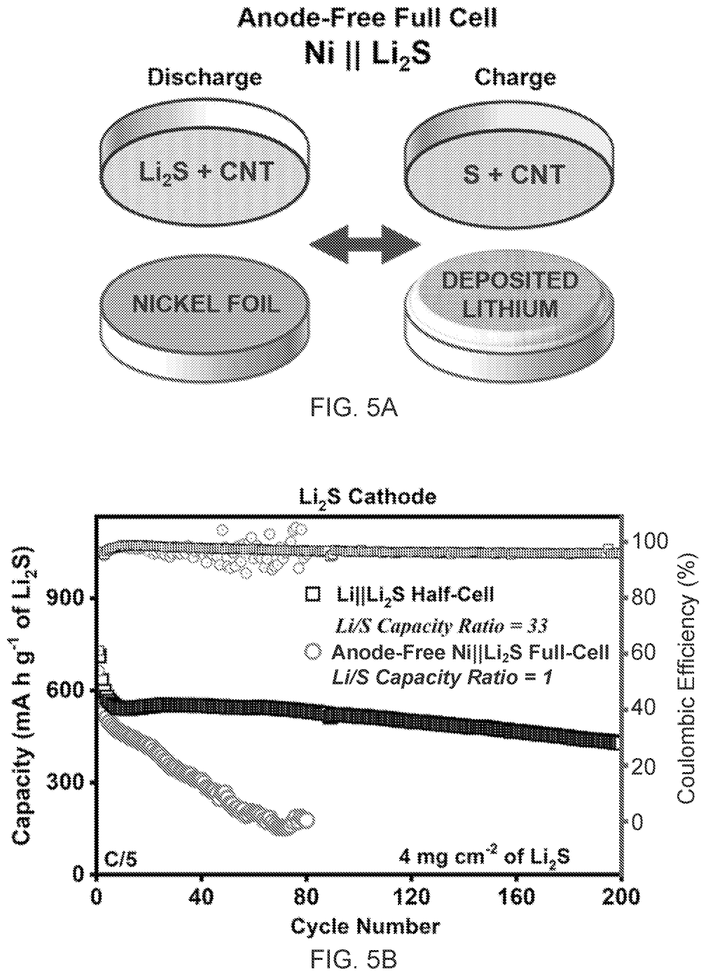

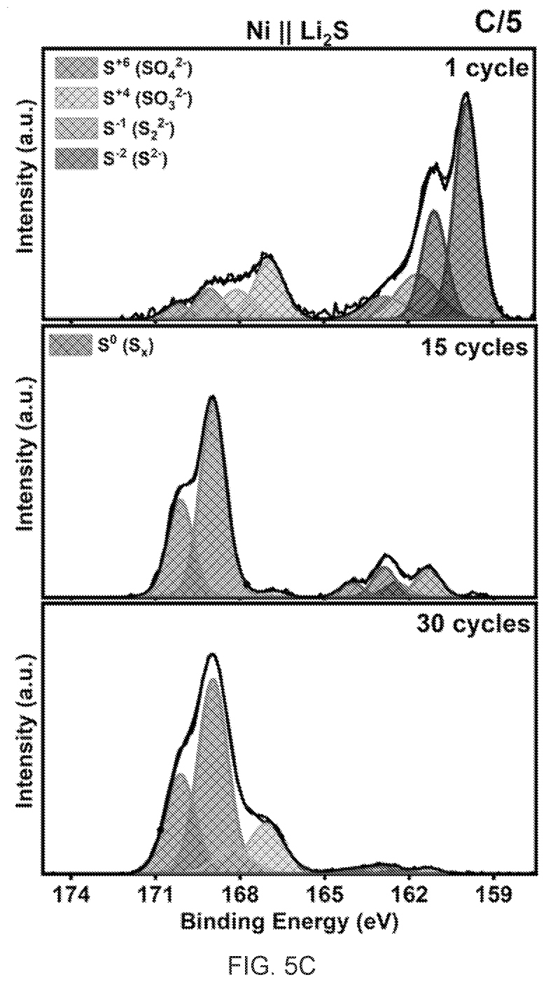

Anode-free Full Cells and the Role of a Sulfide-rich SEI. In this example, the anode-free full-cell configuration (Ni∥Li₂S) is used to effectively investigate the dynamics of lithium deposition. Assembled in the discharged state, it employs a fully-lithiated Li₂S cathode paired with a bare nickel foil current collector (FIG. 5A). The amount of lithium and sulfur is stoichiometrically balanced and the Li/S capacity ratio (analogous to N/P ratio) is exactly equal to 1. The elimination of free lithium metal and excess lithium inventory leads to a significant enhancement in energy density and alleviates many safety concerns. More importantly, it allows electrochemical performance to be constrained entirely by the efficiency of lithium plating/stripping. Capacity fade can now be used to model lithium inventory loss rates. This makes anode-free full cells excellent templates for realistic evaluation of cyclability in lithium-metal batteries.

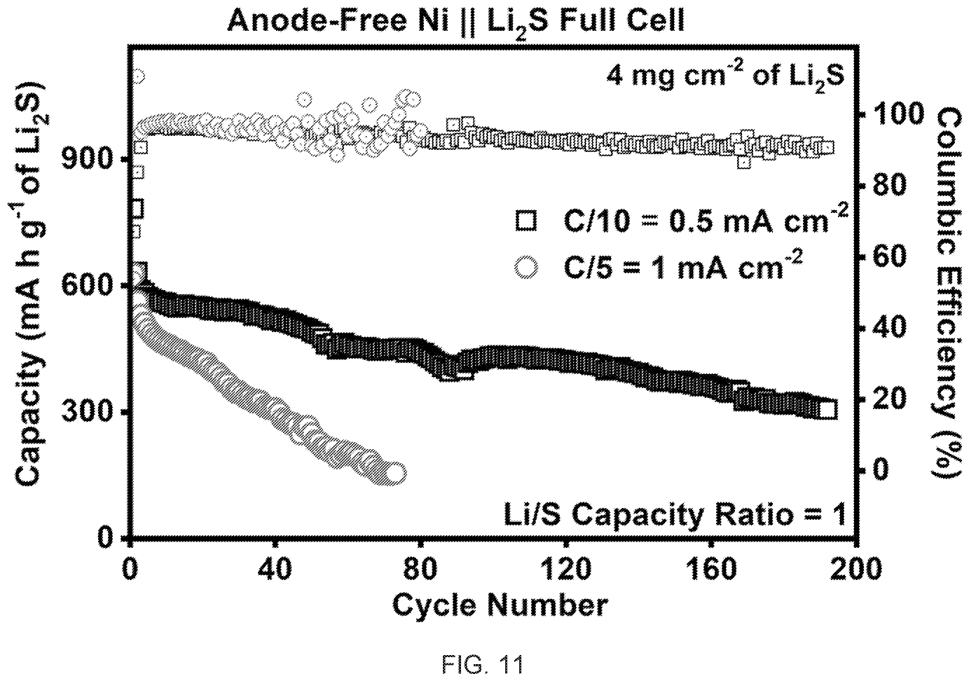

The rapid capacity fade of the anode-free Nil Li₂S full-cell (0% excess lithium) compared to the Li∥Li₂S half-cell (3300% excess lithium) at C/5 (1 mA cm⁻²) clearly demonstrates the irretrievable loss of lithium inventory with cycling and the impact of limited lithium inventory on electrochemical performance (FIG. 5B). The lithium inventory loss rate is calculated to be 2.02% per cycle. X-ray photoelectron spectroscopy (XPS) analysis of the deposited lithium sheds light on the changes in SEI layer composition accompanying the loss of lithium inventory (FIG. 5C). It reveals a transition from reduced-sulfur (Li₂S₂/Li₂S, between 159 and 165 eV) to oxidized-sulfur (SO₃²⁻, SO₄²⁻, between 165 and 171 eV) species with cycling. The reduced-sulfur species are formed by polysulfide (Li₂Sn) decomposition and intrinsically stabilize lithium deposition in Li—S batteries, which is particularly effective at low current densities. This can be inferred from the smaller lithium inventory loss rate (0.38% per cycle) at C/10 rate (FIG. 11). Their replacement by oxidized-sulfur species is attributed to electrolyte salt (lithium bis(trifluoromethanesulfonyl)imide, or LiTFSI) decomposition, and leads to degradation and eventual irreversible depletion of lithium inventory. This suggests that engineering a stable sulfide-rich SEI layer, which improves the reversibility of lithium deposition and resilience to electrolyte decomposition, could be useful in extending the cyclability of the lithium-metal anode in Li—S batteries at practical current rates.

Introducing Tellurium into the Li—S System. One potential pathway to engineering a stable sulfide-rich SEI layer is to replace the binary sulfide species (Li₂S/Li₂S₂) with ternary sulfide species of the general formula LiₐX_{b}S_{c}, where X is a high-oxidation state cation of an element less electronegative than sulfur. By appropriately choosing element X, the properties of the reduced-sulfur SEI components could be modified towards stabilizing lithium deposition. One particularly attractive candidate element for X is tellurium. Tellurium and sulfur share a similar chemistry as Group 16 chalcogens and form ether-soluble catenated compounds, potentially enabling facile incorporation of tellurium into the sulfide-rich lithium SEI. However, tellurium has lower electronegativity than sulfur and forms more polarizable ions due to its larger size and enhanced shielding effect, potentially enabling higher Li⁺-ion conductivity of the tellurized sulfide-rich interphases on lithium surface.

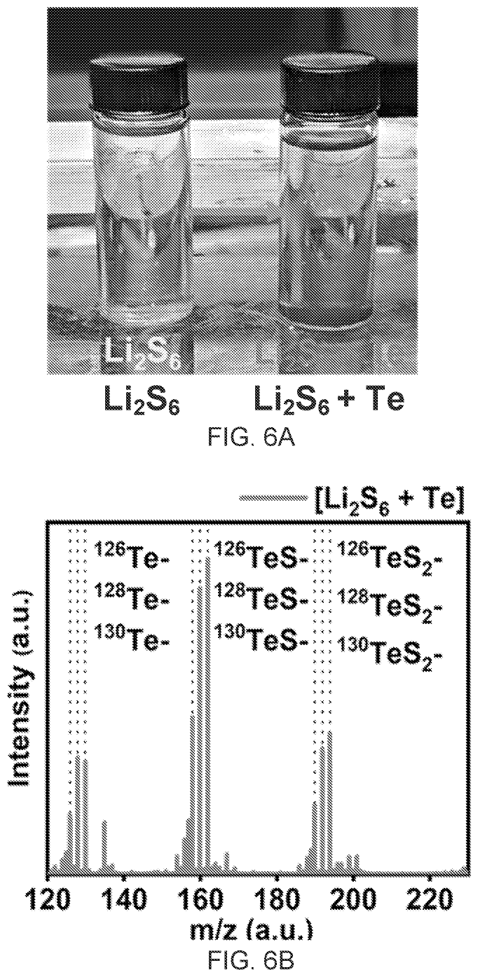

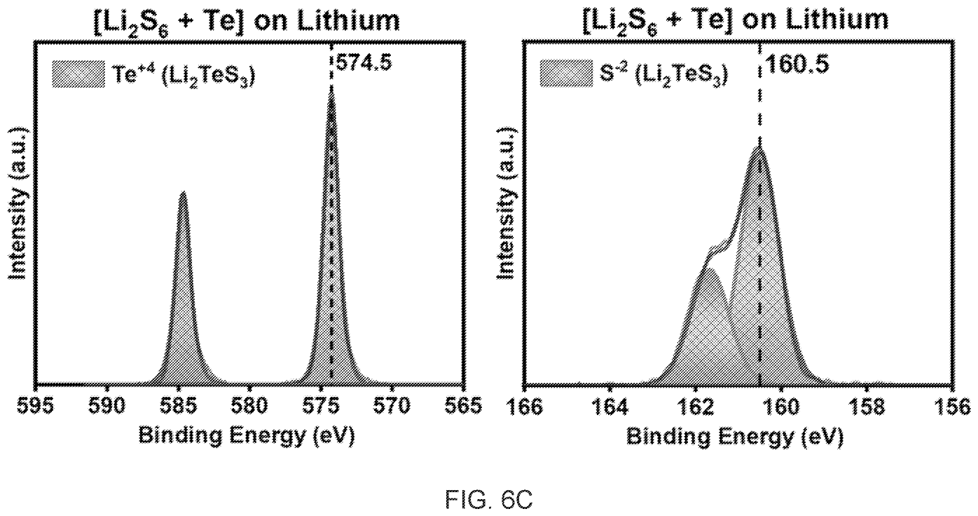

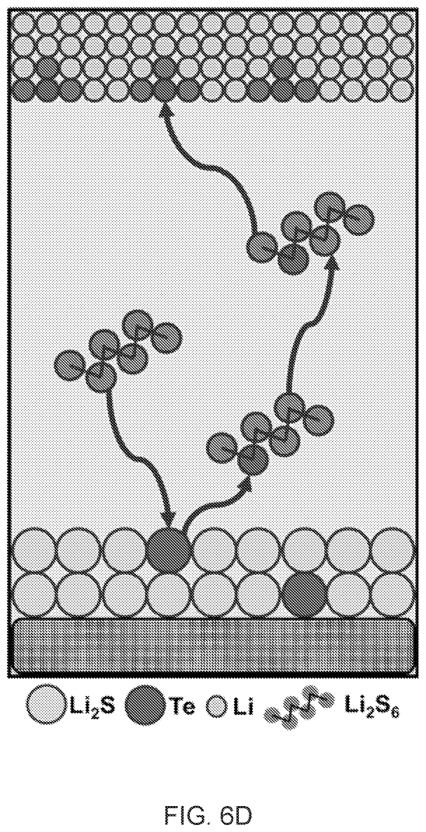

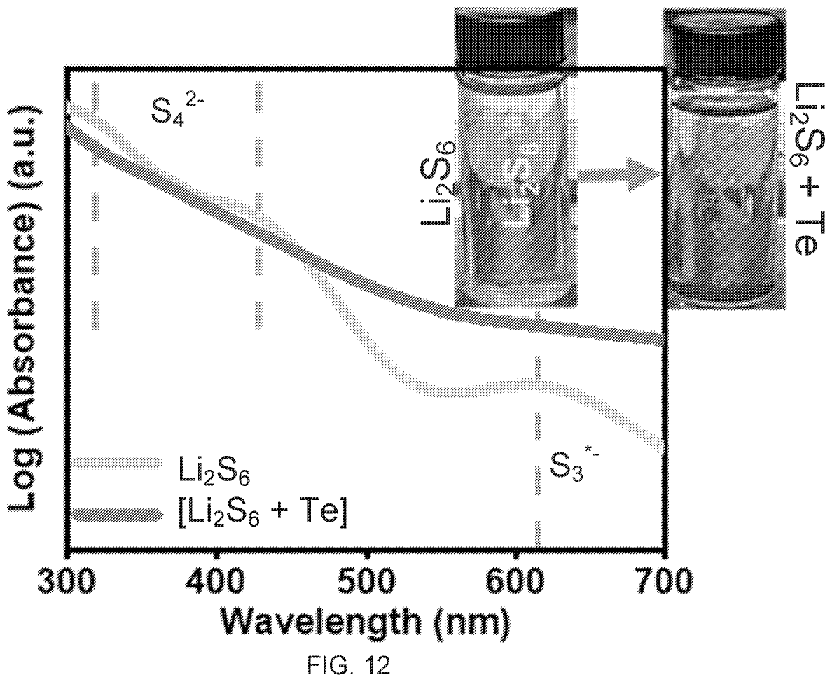

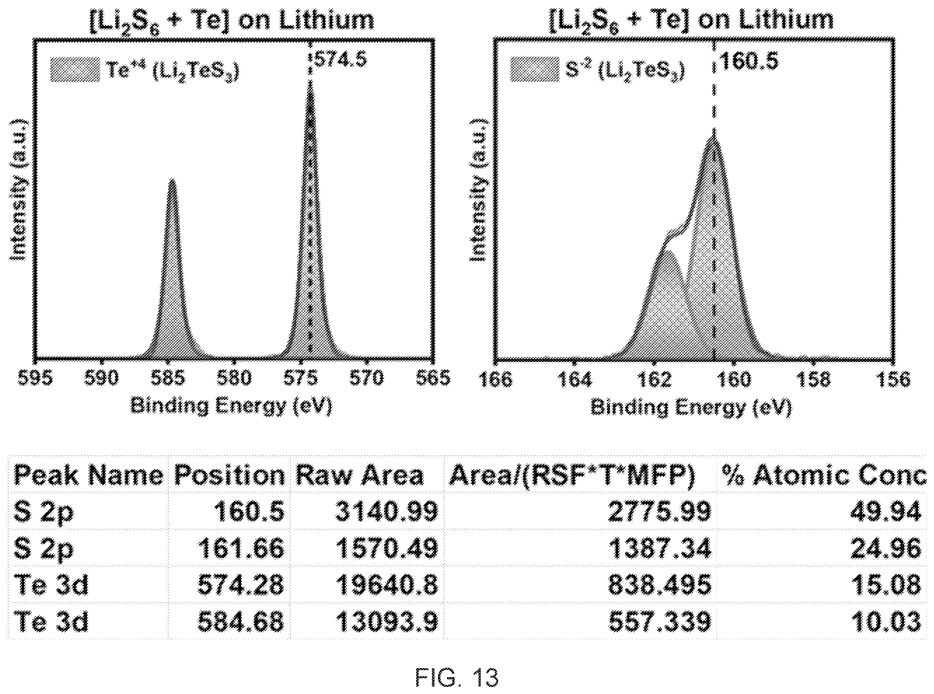

A possible approach to forming the tellurium-containing reduced-sulfur SEI components is substituting tellurium for some of the sulfur atoms in the polysulfide (Li₂Sₙ) chain and allowing their reduction on the lithium surface. In attempting to synthesize tellurium-substituted polysulfide species, we discovered that elemental tellurium)(Te⁰ spontaneously reacts with ethereal solutions of polysulfides to form soluble polytellurosulfide (Li₂TeₓS_{y}) species. FIG. 6A shows the change in color from yellow to red when a 0.02 M Li₂S₆ solution in 1,3-dioxolane/1,2-dimethoxyethane (DOL/DME) is reacted with excess Te⁰ powder undisturbed at room temperature overnight. UV-Vis spectra of the two solutions confirm the reaction of polysulfides (FIG. 12). The residue left after drying the red-colored [Li₂S₆+Te] solution was analyzed by time-of-flight secondary-ion mass spectrometry (ToF-SIMS). Strong signals for TeS⁻ and TeS₂⁻ molecular fragments (separated by 32 amu) were observed, with the appropriate isotopic ratios for ¹²⁶Te, ¹²⁸Te, and ¹³⁰Te (FIG. 6B), confirming the formation of polytellurosulfide species (Li₂TeₓS_{y}). The [Li₂S₆+Te] solution was drop-cast on lithium-metal foil, which was subsequently washed and analyzed with XPS. It revealed peaks for Te in +4-oxidation state and S in −2-oxidation state (FIG. 6C). Elemental ratios obtained from quantification of Te3d and S2p signals (FIG. 13) indicate the presence of lithium thiotellurate (Li₂TeS₃). This confirms the formation of tellurium-containing reduced-sulfur species on the lithium surface.

These results allow for formulation of a straightforward strategy for incorporating tellurium in situ into the sulfide-rich lithium SEI and evaluate its impact on lithium deposition in Li—S batteries. Elemental Te is added to the Li₂S cathode in a 1:10 molar ratio (hereafter designated as Li₂S+0.1Te) and investigated in the anode-free Ni∥Li₂S full-cell configuration. It is anticipated that polysulfides generated from Li₂S cathode would react with Te⁰ additive, forming polytellurosulfides that migrate to the anode side and form Li₂TeS₃ on the deposited lithium. The proposed mechanism is illustrated in FIG. 6D. We hypothesize that the formation of such tellurium-containing reduced-sulfur SEI components could stabilize lithium deposition and improve performance under the limited lithium conditions of anode-free full cells.

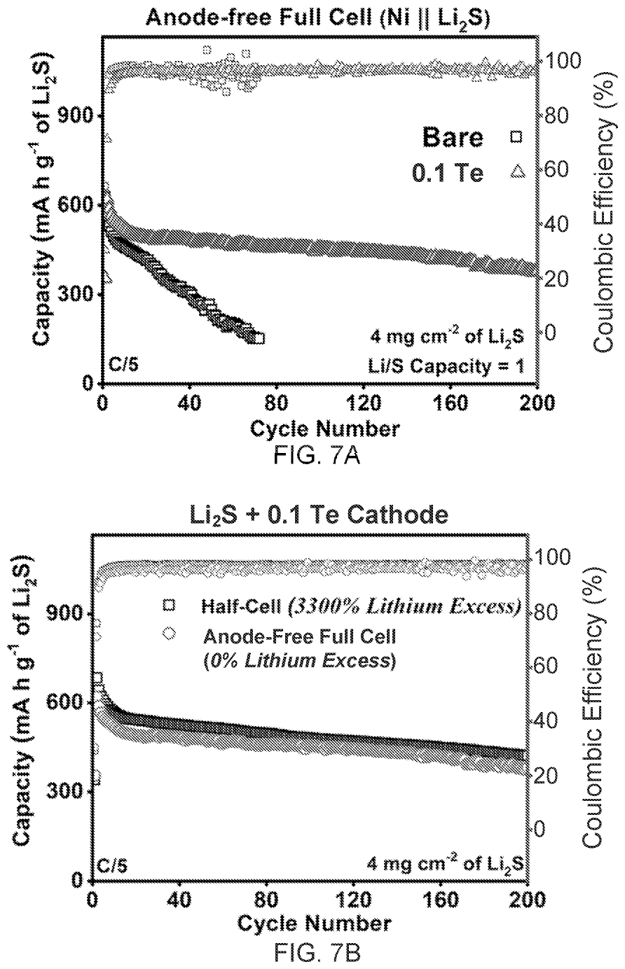

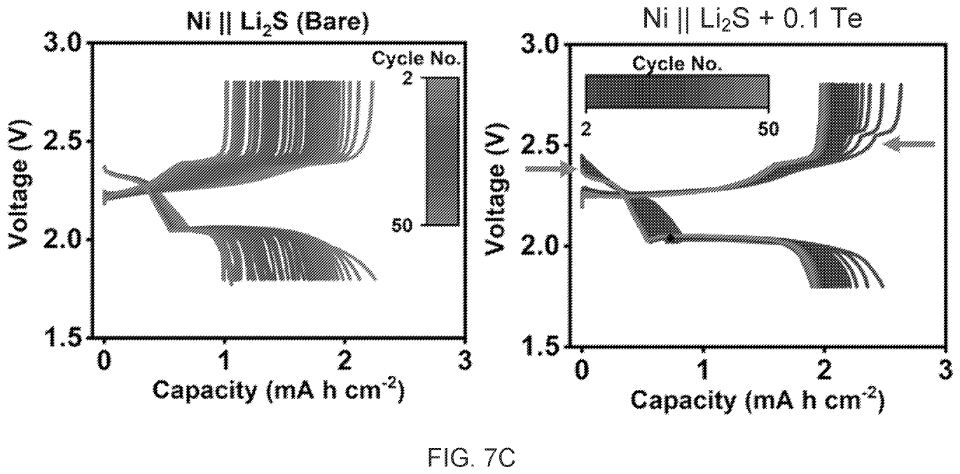

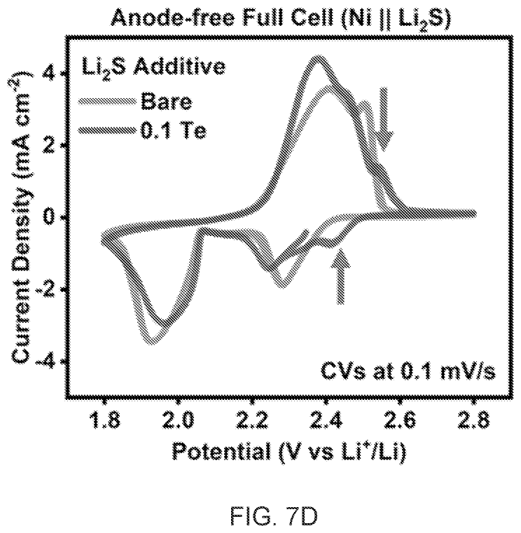

Effect of Tellurium on the Performance of Anode-free Full Cells. The effect of tellurium additive on electrochemical performance of anode-free Ni∥Li₂S full-cells at C/5 rate (1 mA cm⁻²) is seen in FIG. 7A. The Ni∥Li₂S cell with no additive shows rapid capacity fade, with 50% of its peak capacity lost within 34 cycles. This corresponds to poor efficiency of lithium plating/stripping and rapid loss of lithium inventory. In contrast, the addition of tellurium leads to a dramatic improvement in the cyclability of the anode-free full cell. The Ni∥(Li₂S+0.1Te) full cell retains over 50% of its peak capacity for 240 cycles, which corresponds to a seven-fold enhancement in cycle life. The lithium inventory loss rate shows a seven-fold reduction, from 2.02% to 0.28% per cycle. Thus, the introduction of tellurium as a cathode additive leads to a significant stabilization of lithium deposition. The extent of this stabilization is demonstrated in FIG. 7B, where the Ni∥(Li₂S+0.1Te) full cell (0% lithium excess) shows nearly identical electrochemical performance as the Li∥(Li₂S+0.1Te) half cell (3300% lithium excess). Despite the complete elimination of excess lithium, the anode-free full cell with Te additive maintains its cyclability due to the improved reversibility of lithium plating/stripping. Thus, the addition of tellurium makes the Li—S system remarkably resilient towards a restriction in lithium supply. FIG. 7C shows the charge/discharge profiles of the anode-free full cells between 2nd and 50th cycles. Compared to the control cell without additive, which shows rapid capacity fade and increasing overpotentials with cycling, the Ni∥(Li₂S+0.1Te) cell exhibits limited capacity fade and low, stable overpotentials.

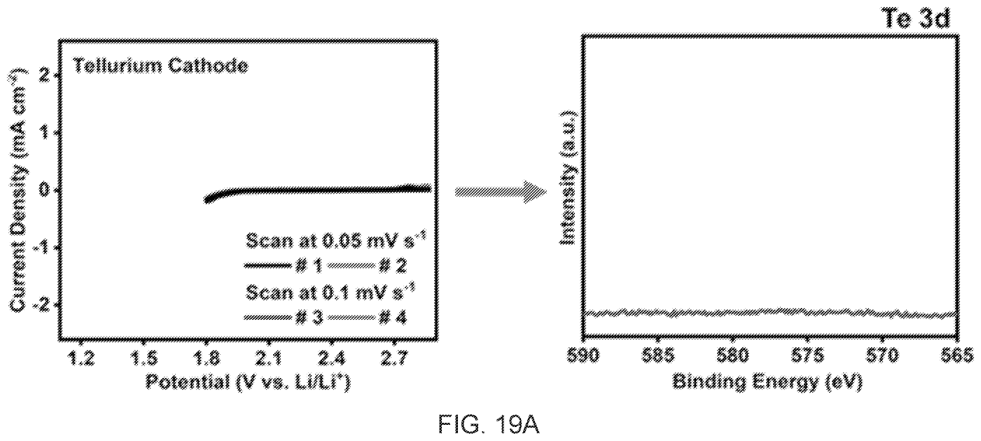

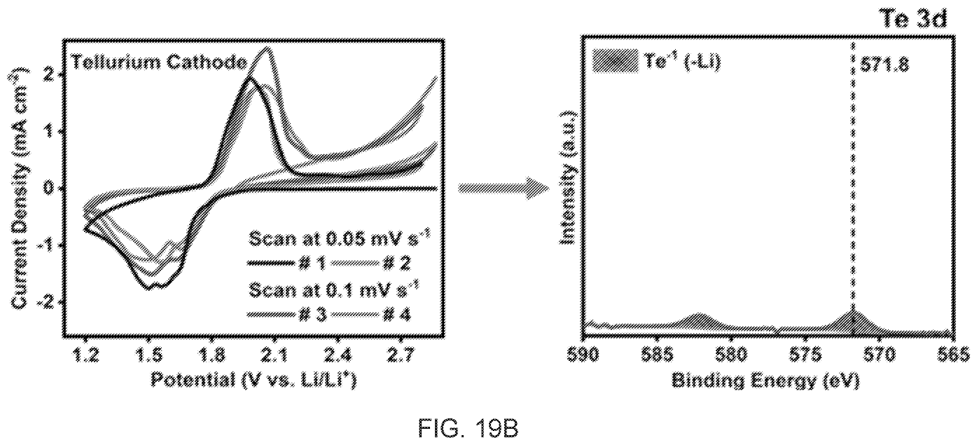

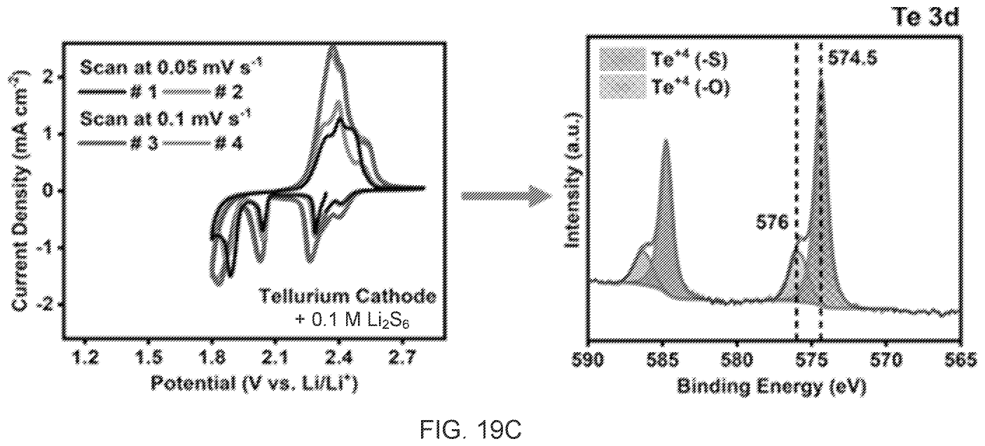

From FIG. 19A, FIG. 19B, and FIG. 19C, tellurium is expected to be electrochemically inactive in the operating voltage range (2.8 V-1.8 V). However, the Ni∥(Li₂S+0.1Te) cell shows two new plateaus in the voltage profiles, which decrease in magnitude until disappearing in the 6th cycle. This is corroborated by two additional peaks that appear in the cyclic voltammograms at 2.55 V (anodic scan) and 2.45 V (cathodic scan) (FIG. 7D), suggesting that tellurium is indeed electrochemically active in the Li—S system. This can be attributed to the reaction of tellurium with long-chain polysulfide intermediates. The disappearance of the plateaus after the first few cycles indicates that the entirety of the added tellurium has been consumed by reaction with polysulfides.

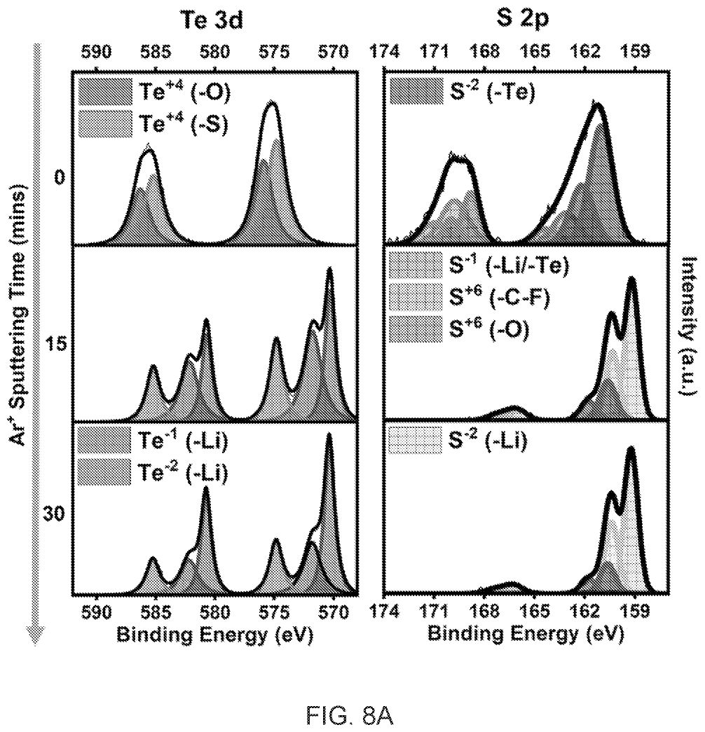

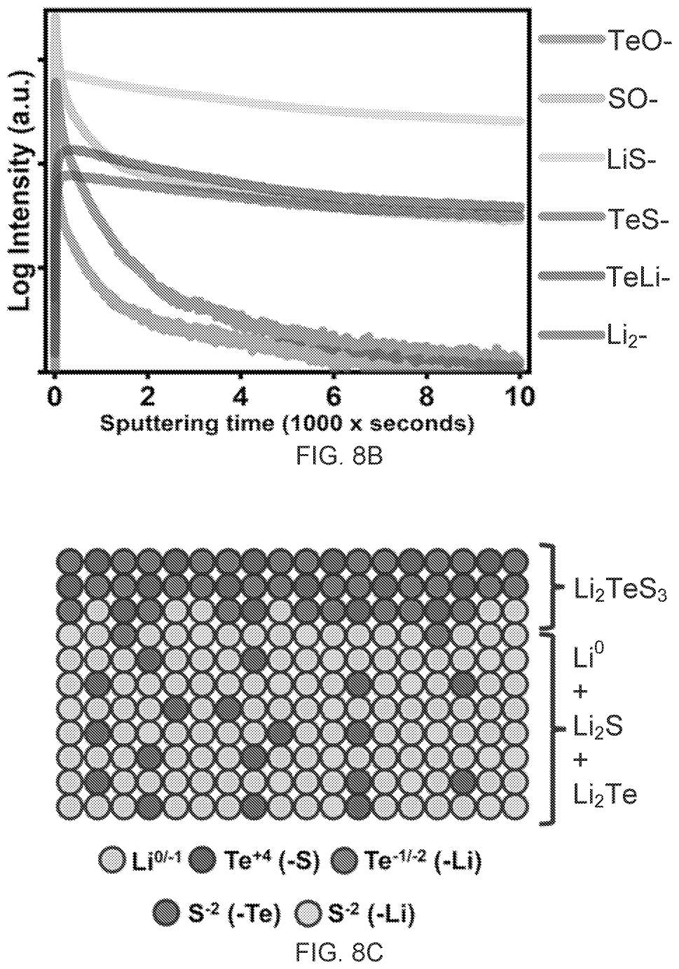

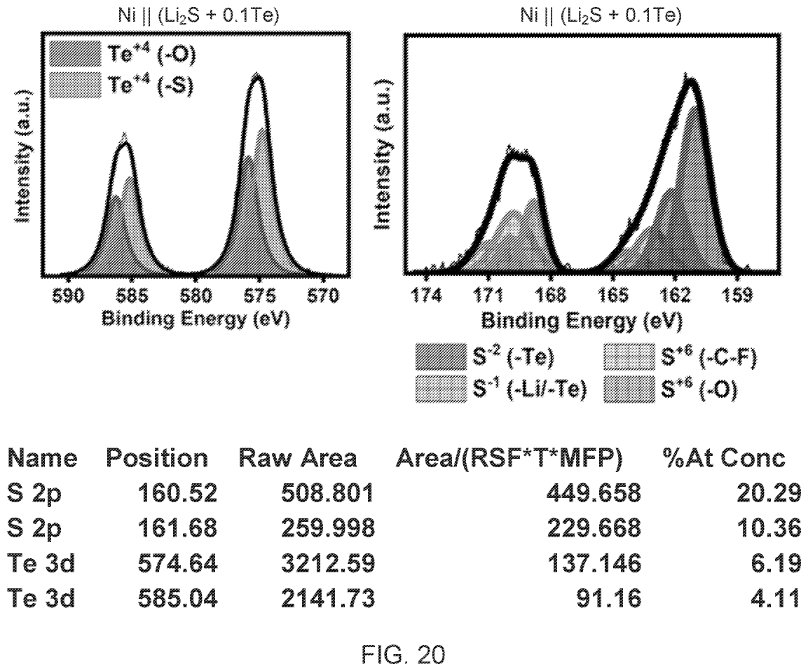

Bilayer Tellurized and Sulfurized Lithium SEI. The successful stabilization of lithium deposition with the introduction of tellurium as a cathode additive in the Li—S system begs the question of how it impacts the composition of the SEI layer formed on lithium surface. The deposited lithium in the anode-free Ni∥(Li₂S+0.1Te) full-cell after 30 cycles was analyzed by XPS (FIG. 8A). It reveals the presence of tellurium in +4-oxidation state, primarily bonded to S at 574.5 eV. Simultaneously, sulfur is found in −2-oxidation state, primarily bonded to Te at 160.5 eV. The sulfur to tellurium ratio, obtained from quantification of Te⁺⁴(—S) and S⁻²(—Te) signals, is calculated to be 2.98 (FIG. 20), identifying the tellurium-containing reduced-sulfur species as lithium thiotellurate (Li₂TeS₃). Here, Te⁺⁴(—S) means Te⁺⁴ is bonded to sulfur and S⁻²(—Te) means S⁻² is bonded to Te. It should be emphasized that during cell assembly, tellurium is only present as Te⁰ in the cathode. The transfer of tellurium species from cathode to anode with cycling occurs due to the formation of soluble polytellurosulfides (Li₂TeₓS_{y}), as evidenced in FIG. 7D (See FIGS. 19A-19C for support). Thus, the mechanism proposed in FIG. 6D is successfully demonstrated, and the formation of a tellurized sulfide-rich SEI layer on the lithium surface is achieved by introducing tellurium as a cathode additive.

FIG. 8A also shows the XPS measurements of the deposited lithium at different Ar⁺ sputtered (1 min≈30 nm) depths. With increasing depth, the Te⁺⁴(—S) and S⁻²(—Te) peaks reduce in intensity. They are replaced by two new reduced tellurium peaks—Te⁻¹(—Li) at 572 eV and Te⁻²(—Li) at 570.5 eV, corresponding to Li₂Te₂ and Li₂Te, respectively. A new reduced-sulfur peak S⁻²(—Li) at 159.5 eV, corresponding to Li₂S, also appears. By 30 minutes of sputtering, the peaks for Li₂Te and Li₂S are clearly dominant. Thus, there is a steady transition of the SEI composition from Li₂TeS₃ at the surface to Li₂S and Li₂Te in the bulk of the deposited lithium.

This is confirmed by depth profiles obtained using ToF-SIMS (FIG. 8B) for various molecular fragments of the lithium SEI. The TeS⁻ fragment (from Li₂TeS₃) shows a sharp initial peak at 20 s, but then falls off rapidly with increasing depth to 0.2% of its peak intensity at 10,000 s. In contrast, the TeLi⁻ fragment (from Li₂Te₂/Li₂Te) slowly increases to a peak intensity at 350 s and then declines much more gradually, retaining 29% of its peak intensity at 10,000 s. The depth profiles of LiS⁻ (from Li₂S₂/Li₂S) and Li₂⁻ (from metallic lithium) fragments closely follow that of TeLi⁻. Due to the strongly reducing nature of lithium metal, the tellurium and sulfur containing species are reduced to Li₂Te and Li₂S. Thus, deposited lithium in the presence of Te additive has a unique bilayer SEI structure (FIG. 8C). While the top layer of the lithium SEI closest to the electrolyte is composed of Li₂TeS₃, the bulk of the deposited lithium is enriched with Li₂Te and Li₂S.

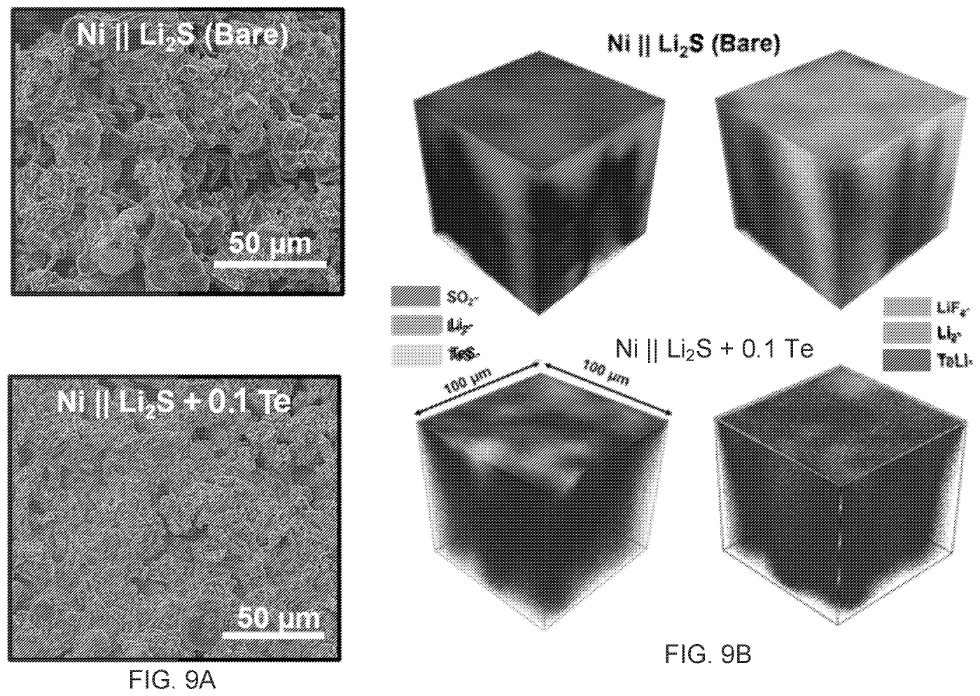

Effect of Tellurium on Electrolyte Decomposition. The impact of the unique bilayer tellurized and sulfurized lithium SEI on the morphology of the deposited lithium can be seen from scanning electron microscopy (SEM) images (FIG. 9A). Without the use of any additive, the deposition of lithium exhibits typical characteristics of mossy growth mechanisms, i.e., high porosity, large surface area, and fibrous needle-like formations. However, the use of tellurium as cathode additive leads to smoother, denser, and more planar morphology of the deposited lithium, with distinctly lower porosity and smaller surface area.

The difference in the exposed surface area of the deposited lithium between the two cases should also engender a difference in the amount of electrolyte that can ingress into the void spaces and decompose on the lithium surface. To confirm this, the deposited lithium in the Ni∥Li₂S full-cells after 30 cycles was analyzed with ToF-SIMS (FIG. 9B). In the control case, the deposited lithium (Li₂⁻ molecular fragment) is covered with a thick layer of electrolyte decomposition products, as oxidized-sulfur (SO₂⁻) and fluorinated (LiF₂⁻) molecular fragments. The formation of these resistive SEI components is concomitant with high-surface area mossy deposition of lithium. However, with the addition of tellurium, electrolyte decomposition is significantly mitigated, and the resistive oxidized-sulfur and fluorinated species are restricted to a thin layer on the top surface. This is a consequence of smoother, denser, and planar deposition of lithium. Instead, a thin layer of lithium thiotellurate (TeS⁻) serves as a protective and stabilizing tellurium-containing sulfide-rich SEI.

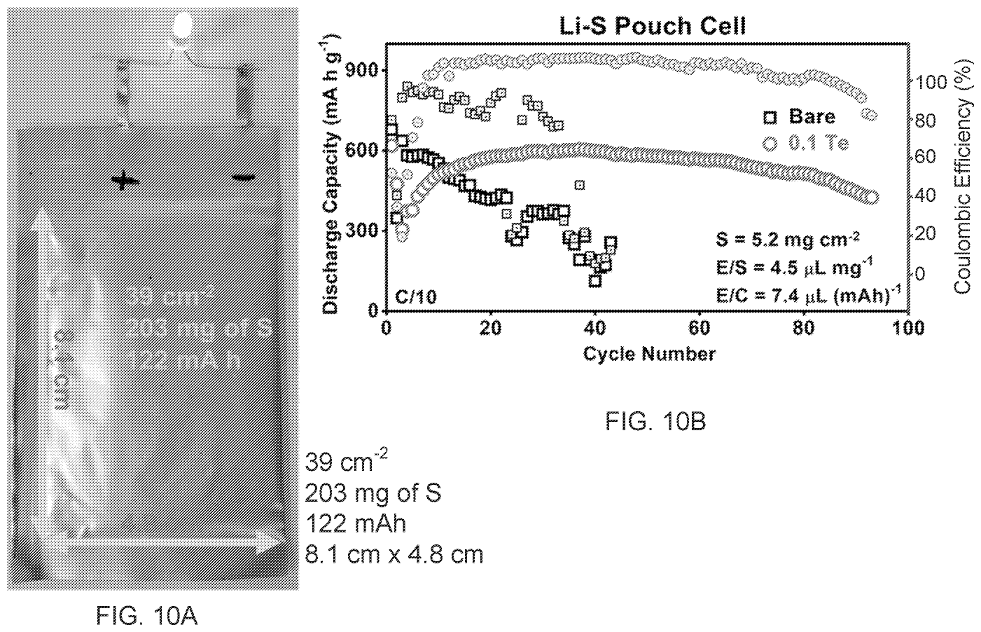

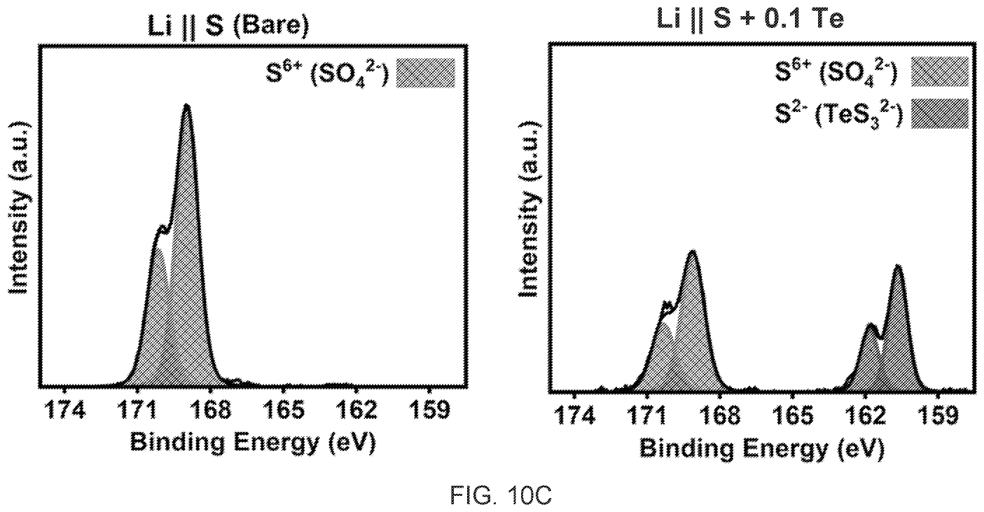

Effect of Tellurium on Lean-electrolyte Performance. The severe side reactions between lithium and electrolyte is a primary reason for premature failure of lithium-limited and electrolyte-limited Li—S batteries, accounting for rapid depletion of lithium inventory, drying up of electrolyte supply, and formation of highly resistive interphases. The alleviation of electrolyte decomposition on the lithium surface with Te additive promises enhanced electrochemical performance under lean-electrolyte conditions. To confirm this, large-area (39 cm⁻²) pouch cells were assembled with a lithium anode, a high-loading sulfur cathode (5.2 mg cm⁻²), and a low E/S ratio of 4.5 μl mg⁻¹ (FIG. 10A). Elemental tellurium (Te⁰) was added to the sulfur cathode in 1:10 molar ratio (hereafter designated as S+0.1Te). The pouch cells were operated at C/10 rate (0.87 mA cm⁻²).

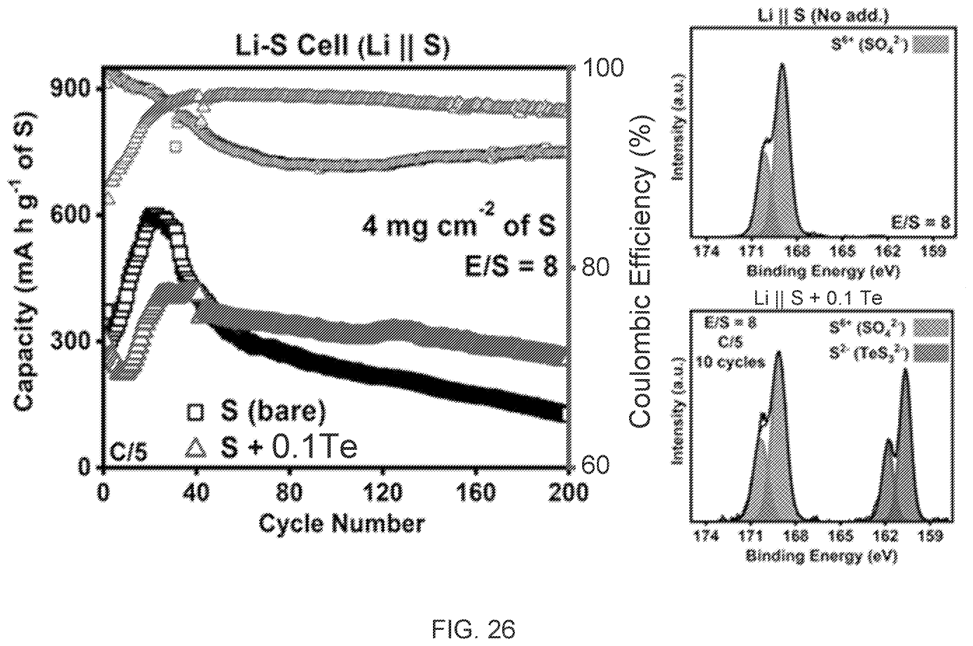

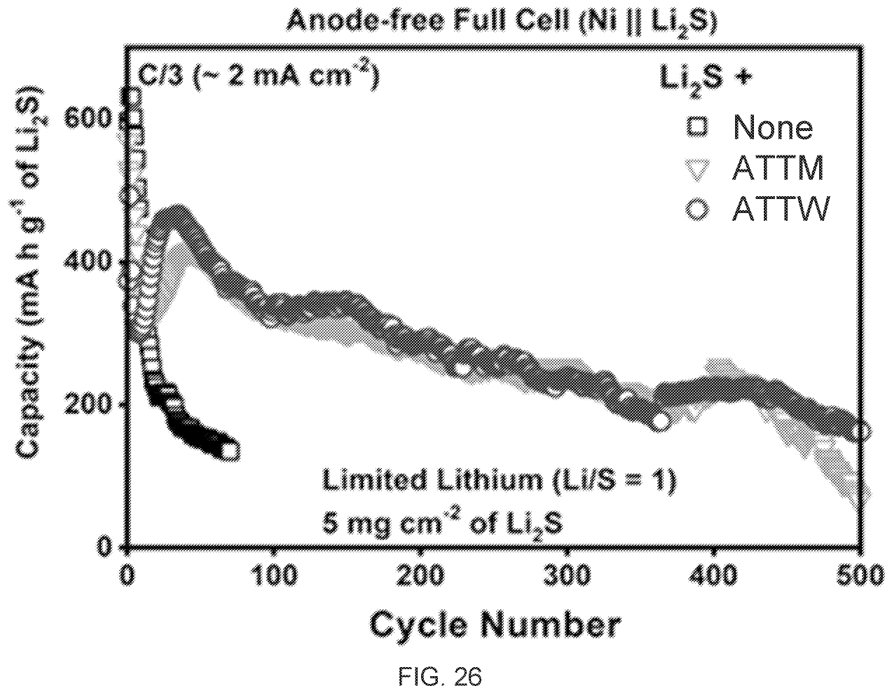

Under these cell design and testing conditions, the addition of Te has a dramatic effect on the cyclability of the pouch cell. In contrast to the control cell without any additive, which fails within 25 cycles, the pouch cell with tellurium additive shows stable cycling for nearly 100 cycles (FIG. 10B, FIG. 26). A significant improvement in Coulombic efficiency is also observed. XPS analysis of the lithium surface harvested from lean-electrolyte coin cells shows the formation of lithium thiotellurate (Li₂TeS₃) as a tellurium-containing reduced-sulfur SEI component. Electrolyte decomposition, as evidenced by the formation of oxidized-sulfur species, is significantly reduced (FIG. 10C). This helps sustain the limited electrolyte for a longer number of cycles and prevents premature drying-up and failure of the cell. Thus, the stabilizing effect of tellurium on lithium deposition in Li—S batteries is robust enough to improve cyclability under both limited lithium and limited electrolyte conditions.

Discussion Why is lithium deposition successfully stabilized by introducing tellurium into the Li—S system? Answering this question requires comparing the properties of the binary sulfide (Li₂S) SEI components formed in the control system with the ternary sulfide (Li₂TeS₃) and telluride (Li₂Te) SEI components formed with the addition of tellurium. In contrast to ionic Li₂S, the Te—S bond in Li₂TeS₃ has significant covalent character due to the small electronegativity difference between sulfur (2.58) and tellurium (2.1). This reduces the electron density on the sulfur atoms, which is expected to reduce the diffusion barrier for lithium ions. Compared to insulating Li₂S (bandgap=3.39 eV), Li₂TeS₃ is a red-colored semiconductor (bandgap=0.97 eV). Despite the narrow bandgap, there is no evidence to suggest deposition of metallic lithium due to electron tunneling through Li₂TeS₃. One the other hand, the implied partial electron delocalization in Li₂TeS₃ might contribute to an alleviation of the non-uniform electric fields that cause mossy lithium deposition. Li₂Te also possesses similar advantages as Li₂TeS₃ over Li₂S. It has a bandgap of only 2.52 eV. The larger size and higher polarizability of telluride anions compared to sulfide anions is also expected to lower the diffusion barrier for lithium ions. This leads to significantly higher ionic conductivity of Li₂TeS₃ and Li₂Te over Li₂S, which (i) makes Li⁺-ion flux on the surface more uniform, leading to a smooth, planar, and dense lithium deposition, and (ii) mitigates electrochemical inaccessibility of lithium enclosed by SEI layer, reducing “dead” lithium.

These results open the possibility of achieving comparable results with other LiₐX_{b}S_{c} ternary sulfides as reduced-sulfur lithium SEI components. Here, X is an element less electronegative than sulfur, and can be chosen from transition metals, metalloids, and non-metals. The properties of LiₐX_{b}S_{c}, especially Li⁺-ion conductivity and covalent character, depend strongly on the electronegativity difference between X and sulfur, thereby conferring similar advantages as Li₂TeS₃ over Li₂S. Another advantage is the potential for in situ formation of LiₐX_{b}S_{c} SEI components, obviating the considerable technical challenges with ex situ fabrication of artificial SEIs. Broadly, LiₐX_{b}S_{c} ternary sulfides can be explored as a class of artificial SEI layers for improving the reversibility of lithium deposition in lithium-metal batteries.

This example demonstrates the successful stabilization of lithium deposition in Li—S batteries using a simple inclusion of elemental tellurium (Te⁰) in the sulfur/Li₂S cathode. Improved electrochemical performance is demonstrated under realistic lithium-limited (anode-free Ni∥Li₂S full-cell) and electrolyte-limited (Li∥S pouch cell) conditions. The stabilizing tellurium-containing SEI components (Li₂TeS₃/Li₂Te) are found to form in situ through the generation of soluble polytellurosulfides, shedding light on the novel chemistry of tellurium in polysulfide-rich electrolytes. The addition of tellurium is facilely extensible to most sulfur/Li₂S cathode designs. This represents a significant step towards resolving the fundamental trade-off between energy density and cyclability in Li—S batteries. The stabilization of lithium deposition with tellurium also alleviates the potential safety concerns associated with dendrite growth and consequent risk of internal shorts.

This example also establishes a comprehensive and robust new framework for evaluating lithium deposition in Li—S batteries, and broadly, lithium-metal batteries. By utilizing limited lithium inventory and limited electrolyte supply to constrain electrochemical performance, the impact of different stabilization approaches on reversibility of lithium plating/stripping can be effectively determined. Limited lithium inventory can be achieved using thin lithium foils, or more elegantly, anode-free full cell configuration. Limited electrolyte supply is most reliably achieved in large-area pouch cells. Using this framework will elucidate the complex degradation mechanisms that underlie premature failure of lithium-metal anodes. This will expedite progress on critical cell design, testing, and performance parameters, bringing Li—S batteries closer to commercial reality.

Methods. Li₂S Cathode Preparation. Commercial multi-walled carbon nanotubes (MWCNT, Sigma Aldrich) and commercial lithium sulfide (Li₂S, Sigma Aldrich) was ball-milled together in a 1:4 ratio into a slurry in a PTFE bottle. A 1:1 (volume) mixture of 1,3-Dioxolane (DOL, Sigma Aldrich) and 1,2-Dimethoxyethane (DME, Sigma Aldrich) was used as the slurry medium. The ratio of Li₂S/CNT composite to added ethereal solvents was 1:20. The PTFE bottle was filled halfway through with zirconia balls of 2-5 mm diameter for ball-milling, while the rest was used for the Li₂S/CNT composite and the ethereal solvents. The tellurium (Te, Sigma Aldrich) cathode additive was added to the slurry mixture in a 1:10 molar ratio with Li₂S. The PTFE bottle was then sealed with electric tape and ball-milled for 24 h at 75 rpm on a long roll jar milling system (US Stoneware 802CVM). This created a fine, uniform, well-dispersed slurry. The slurry was then drop-cast between two pieces of 7/16 inch dia. carbon paper (Avcarb P50) for a final loading of 4 mg cm⁻² of Li₂S. They were then dried in the glove box ambient to yield binder-less, free-standing Li₂S cathodes.

Sulfur Cathode Preparation. Ketjenblack (KB, EC-600JD, AkzoNobel) was melt-diffused with sulfur (sublimed, 99.5%, Alfa Aesar) in a 1:9 weight ratio by heating a well-ground mixture to 150° C. for 6 h to obtain the S/KB composite. This composite was dry ball-milled with Te such that the S/Te molar ratio was 10:1 to obtain the S/Te/KB composite. Aqueous slurries were made using a binder consisting of polyethylene oxide (average MW ˜4,000,000, Sigma Aldrich) and polyvinylpyrrolidone (average MW ˜1,300,000) in 4:1 wt. ratio. The Te-based slurry consisted of 85% S/Te/KB composite, 9% binder, and the rest as conductive carbon. The control S slurry consisted of 62.5% S/KB composite, 9% binder, and the rest as conductive carbon. These ratios ensured the same sulfur content for fair a comparison. These slurries were doctor-blade cast on carbon coated Al-foil (MTI corporation) and dried in-vacuo for 24 h to obtain cathodes having a sulfur loading of 5±0.5 mg cm⁻².

Electrochemical Measurements. The Li₂S cathodes were assembled into Li∥Li₂S half-cell and anode-free Ni∥Li₂S full-cells in CR2032 coin cell format inside an argon-filled glove box for electrochemical measurements. Two pieces of Celgard 2325 tri-layer separator were used in all cases. The electrolyte used was 1 M lithium bis(trifluoromethanesulfonyl)imide (LiTFSI, Sigma Aldrich)+0.1 M lithium nitrate (LiNO₃, Acros Organics) in a 1:1 (volume) DOL/DME cosolvent. The electrolyte amount was not controlled for the investigations with limited lithium inventory to isolate any effects of electrolyte loss and obtain reliable results. Lithium foil (Sigma Aldrich) or nickel foil (MF-NiFoil-25u, MTI Corporation) was used without modification as the anode substrate in Li∥Li₂S half-cell and anode-free Ni∥Li₂S full-cells, respectively. All cells were rested for 6 h before measurements. The cells were cycled at C/5 rate between the voltage limits of 2.8 and 1.8 V. The initial charging step was done at C/20 rate, with a 20-hour time limit and a 4 V voltage limit. Ni∥Li half-cells were assembled with Ni foil on the anode side and a lithium-metal disc of 7/16 inch diameter on the cathode side. Coulombic efficiency was determined by plating and stripping 1 mA h of Li with a 2 V voltage limit. Every cycle was followed by electrochemical impedance spectroscopy (EIS) measurements in the frequency range of 10⁶ Hz to 10⁻¹ Hz. Cyclic voltammetry (CV) data were collected in the potential range of 2.8 to 1.8 (or 1.2) V at different scan rates (0.05-0.2 mV s⁻¹). All electrochemical measurements were conducted with an Arbin battery cycler or a Biologic VMP-3 potentiostat.

Pouch-cell fabrication and testing. Single-stack soft-packaging pouch cells were fabricated with the electrodes having a dimension of 8.1 cm×4.8 cm (˜39 cm²). The cells were assembled in a glove-box with the blade-cast cathode, Celgard 2500 separator and Li-metal attached to Ni-foam as the anode. Electrolyte was injected such that the E/S ratio was maintained at 4.5 μL mg′. The cells were sealed and removed from the glovebox for testing. They were rested for 6 h before galvanostatic cycling. The cells were cycled at C/20 rate between the voltage limits of 2.5 and 1.65 V with a 20-hour time limit for 3 cycles to activate the cathode, before being tested at C/10 rate for the rest of the cycles.

Materials Characterization. The nickel foils with the deposited lithium in the anode-free Ni∥Li₂S full cells and half cells were harvested after carefully disassembling the cells, rinsing with excess DOL/DME cosolvent to wash off any soluble products, and drying inside a glove box ambient. A FEI Quanta 650 FE-SEM was used for obtaining the SEM images. A Kratos Axis Ultra DLD Spectrometer was used for X-ray photoelectron spectroscopy (XPS) characterization. The samples were transferred to the XPS instrument with an air and moisture-sensitive stainless-steel transfer chamber. A monochromatic Al Kα source of energy 1468.5 eV at 12 kV and 10 mA was used for collecting the spectra, with a 20-eV pass energy and 0.1 eV step size. The charge neutralizer was switched off to avoid any effect on peak positions or line shapes. An attached Ar gas cluster ion source operating in monoatomic mode was used for sputtering the surface with Ar⁺ ions. A TOF. SIMS 5 spectrometer (ION-TOF GmbH) was used for time-of-flight secondary ion mass spectroscopy (ToF-SIMS) characterization. The analysis chamber was maintained with an ultrahigh vacuum at a pressure less than 2×10⁻⁹ mbar. The measurements were done in the negative mode with a 500 eV Cs⁺ ion beam used to sputter the deposited lithium and generate the secondary ions (or molecular fragments). For depth profiling, a pulsed (20 ns) 30 keV Br⁺ ion beam was used in the high current mode. The sputtering area was 300×300 μm², while the analysis was conducted over 100×100 μm².

Calculation of Lithium Inventory Loss Rate. In an idealized full cell with a limited lithium inventory (say N/P ratio≈1), Coulombic efficiency (CE) may be used as a perfect predictor of capacity fade. Assuming that there is no capacity loss at the cathode, the fraction of initial capacity retained after n cycles is

$$\frac{{Cap}_{n}}{{Cap}_{1}} = {\prod }_{p = 1}^{n} {CE}_{p} = {( GCE )}^{n}$$

Here GCE is a geometric mean of CE values up to n cycles, and CE is taken to be a fraction of 1. If Coulombic efficiency is assumed to be a constant throughout the n cycles, the formula reduces to

$$\frac{{Cap}_{n}}{{Cap}_{1}} = {( CE )}^{n}$$

This allows calculation of the number of cycles n before the capacity falls below 50% of initial capacity at different values of Coulombic efficiency CE using the formula

$$n = \frac{ln ( 0.5 )}{ln ( CE )}$$

TABLE 1

| Coulombic Efficiency (%) | No. of Cycles |
|---|---|
| 90 | 7 |
| 95 | 14 |
| 98 | 35 |
| 99 | 69 |
| 99.8 | 347 |
| 99.95 | 1386 |

However, these formulas assume that there is no “cross-talk” between the two electrodes and the electrodes are stable during rest. This assumption is not true for systems containing soluble redox mediators that shuttle between the two electrodes, leaking active material and free electrons. Li—S batteries, with soluble polysulfide intermediates, are the perfect example of such systems. In all investigations of anode-free Li—S full cells, there are wide discrepancies in the predicted cycle life based on CE values and the actual cycle life observed. For instance, the average CE for the anode-free Ni∥Li₂S full cell in FIG. 5B at C/10 rate is 94.68%, corresponding to a predicted cycle life (50% capacity retention) of 13 cycles. However, the actual experimental value is 185 cycles. Hence, Coulombic efficiency can no longer be used as a perfect predictor of capacity fade in Li—S batteries.

However, the actual capacity fade observed in the anode-free Ni∥Li₂S full cell can be used to derive a parameter analogous to Coulombic inefficiency (100-CE). This is the Lithium Inventory Loss Rate (LILR). It can be defined using the formula

$$\frac{{Cap}_{n}}{{Cap}_{1}} = {( 1 - \frac{LILR}{100} )}^{n}$$

In this example, the cycle number at which 50% of the initial capacity is reached is used as n. In addition, the initial capacity is taken at four cycles. This is due to the observation that the initial losses in capacity (first three cycles) appear to be engendered at the Li₂S cathode. The calculation for LILR can then be simplified to

$$LILR = 100 ( 1 - {e}^{\frac{ln ( 0.5 )}{n}} ) = 100 ( 1 - \sqrt[n]{0.5 )}$$

These calculations use two simplifying assumptions. First, it is assumed that the lithium inventory loss in each cycle is a fixed percentage (LILR) of the electrochemically active lithium in that cycle, and this percentage is constant across all cycles. This assumption generally holds true in the “stable cycling” region of the anode-free full cell, prior to failure. Second, the entirety of capacity loss is assumed to come from lithium inventory loss. The cathode is assumed to cause no losses in capacity. This is not necessarily the case, since Li∥Li₂S half cells, whose performance is reflective of the Li₂S cathode, show a measurable loss in capacity with cycling. If cathode losses are accounted for, the actual LILR value will be smaller than the calculated one. Nevertheless, the approximate LILR value is a useful parameter for comparing performance of different anode-free full cells.

Figure Captions. FIG. 5A. Schematic illustration of the anode-free full-cell with Li₂S cathode and Ni current collector. FIG. 5B. Electrochemical performance of Li∥Li₂S half-cell and anode-free Ni∥Li₂S full-cell at C/5 rate. FIG. 5C. XPS (S2p) analysis reveals the evolution of lithium SEI with cycling, showing the replacement of reduced-sulfur by oxidized-sulfur species.

FIG. 6A. Color change of Li₂S₆ when reacted with excess Te due to formation of soluble polytellurosulfides (Li₂TeₓS_{y}), confirmed by ToF-SIMS (FIG. 6B), with the correct isotopic ratios of Te repeated at 32 amu (=S). FIG. 6C. Formation of Li₂TeS₃ (with Te⁺⁴ and S⁻²) when the polytellurosulfide (Li₂TeₓS_{y}) solution reacts with Li metal, as confirmed by XPS. FIG. 6D. Schematic of the proposed mechanism—(1) dissolution of Te by polysulfides, (2) migration to the anode side, and (3) formation of lithium thiotellurate (Li₂TeS₃) on deposited lithium.

FIG. 7A. Electrochemical performance of anode-free Ni∥Li₂S full cells at C/5 rate, showing a clear improvement with the addition of tellurium. FIG. 7B. Electrochemical performance of Li∥(Li₂S+0.1Te) half-cell and anode-free Ni∥(Li₂S+0.1Te) full cell at C/5 rate, showing their nearly identical performance despite a 97% difference in lithium inventory. FIG. 7C. Charge/discharge profiles of the Ni∥Li₂S (bare) and Ni∥(Li₂S+0.1Te) full cells between 2nd and 50th cycles. FIG. 7D. Cyclic voltammograms (CVs) of the Ni∥Li₂S full cells at a scan rate of 0.1 mV s⁻¹, showing additional peaks that evidence the electrochemical activity of Te due to polysulfides.

FIG. 8A. XPS measurements of the deposited lithium in the anode-free Ni∥(Li₂S+0.1Te) full-cell shows the presence of Li₂TeS₃ on the lithium surface. Depth profiles obtained using Ar+ ion sputtering show a transition from Te⁺⁴/S⁻² (Li₂TeS₃) to Te₋₂ (Li₂Te) and S⁻² (Li₂S) with increasing depth. This is confirmed by depth profiles of various molecular fragments of the lithium SEI components, particularly TeS⁻ and TeLi⁻, obtained using ToF-SIMS (FIG. 8B). FIG. 8C. Schematic of the bilayer tellurized and sulfurized lithium SEI structure

FIG. 9A. SEM images show smooth, dense, and planar deposition of lithium with Te additive, with lower porosity and smaller surface area. This explains why ToF-SIMS (FIG. 9B) of the deposited lithium after 30 cycles reveals the absence of a thick layer of resistive electrolyte decomposition products (SO₂⁻ and LiF₂⁻) with Te additive, instead replaced by a thin layer of thiotellurate species (TeS⁻) on lithium surface.

FIG. 10A. Photograph of the Li∥S pouch cell with 39 cm² area and 5.2 mg cm⁻² sulfur loading delivering 122 mA h capacity. FIG. 10B. Electrochemical performance of the Li∥S pouch cell, showing the effect of tellurium additive on cyclability under lean electrolyte conditions (4.5 μl mg−1). FIG. 10C. XPS analysis of harvested lithium from lean electrolyte coin cells shows the presence of Li₂TeS₃ in the lithium SEI.

FIG. 11. Electrochemical performance of the anode-free Ni∥Li₂S full cell at C/10 (0.5 mA cm⁻²) and C/5 (1 mA cm⁻²) rates. The increase in applied current leads to poorer efficiencies of lithium plating stripping, which brings about faster capacity fade at C/5 rate compared to C/10 rate. The lithium inventory loss rate (LILR) increases from 0.38% per cycle at C/10 rate to 2.02% per cycle at C/5 rate. The low LILR value of the unoptimized Ni∥Li₂S full cell at C/10 rate compares favorably to other anode-free systems reported in the literature and can be attributed to the intrinsic stabilization of lithium deposition in Li—S batteries due to polysulfide intermediates.

FIG. 12. UV-Vis absorption spectra for 0.02 M Li₂S₆ in DOL/DME (1:1) solution, showing the absorption peaks corresponding to S₄²⁻ species and S₃*-radical. When excess tellurium is added to the Li₂S₆ solution and left undisturbed at room temperature overnight, its color changes from yellow to red. UV-Vis absorption shows the disappearance of the peaks corresponding to S₄²⁻ species and S₃*-radical, proving their reaction with tellurium. This indicates the spontaneous reaction of polysulfides with tellurium to form polytellurosulfides (Li₂TeₓS_{y}).

FIG. 13. XPS (Te3d and S2p) measurements for a lithium-metal foil exposed to the [Li₂S₆+Te] polytellurosulfide solution and then washed with blank ether solvent. Peaks for Te⁺⁴ (—S) at 574.5 eV and S⁻² (—Te) at 160.5 eV are observed. Quantification of the peaks yields an atomic ratio for S/Te as 2.99. This clearly indicates the presence of TeS₃²⁻ species, in the form of lithium thiotellurate (Li₂TeS₃).

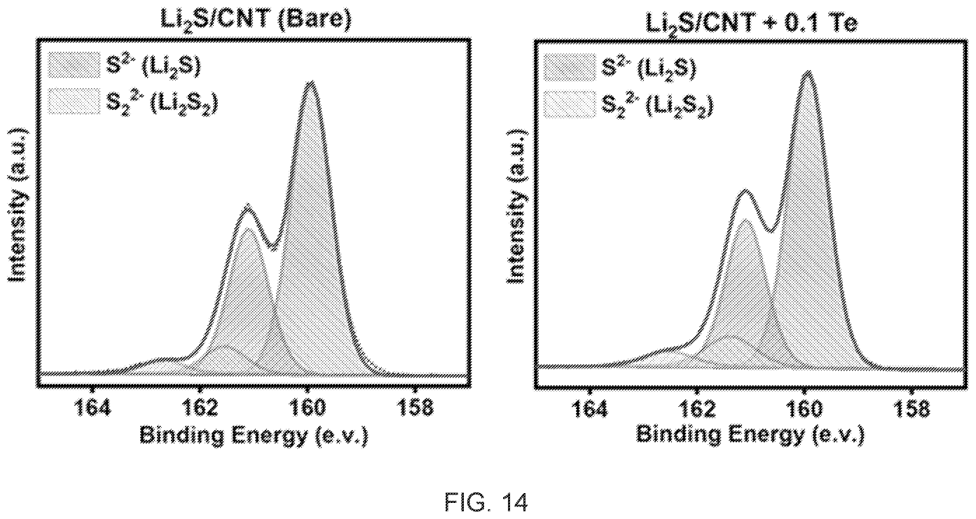

FIG. 14. XPS analysis of the Li₂S/CNT cathodes without and with 0.1 Te additive. The control Li₂S/CNT slurry without additive shows the expected peak for Li₂S and a small peak for Li₂S₂ (up to 9% using quantification). The impurity Li₂S₂ might be present in the commercial Li₂S or introduced from polysulfides in the glove box atmosphere. The S2p signal for the Li₂S/CNT+0.1Te slurry is identical to the control Li₂S/CNT slurry, with no evidence for any Te—S bonds. Thus, Te remains inert with Li₂S during ball-milling and no formation of polytellurosulfides (Li₂TeₓS_{y}) is observed.

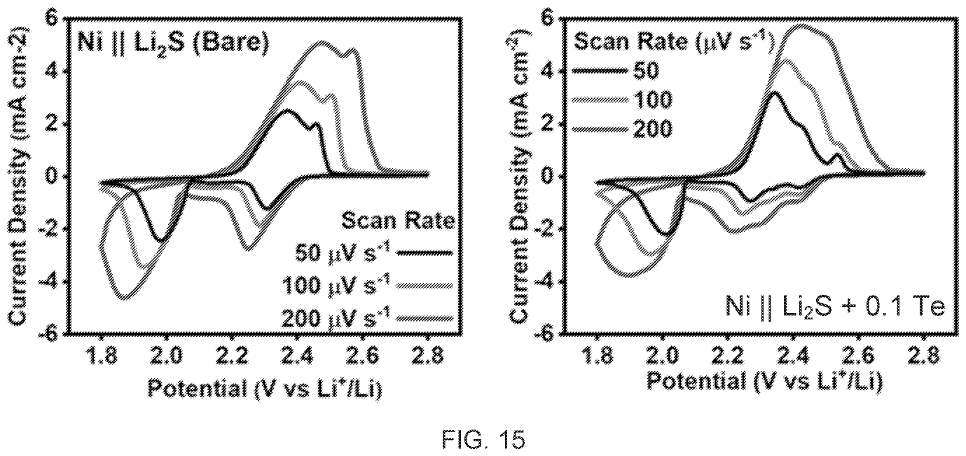

FIG. 15. CVs of the anode-free Ni∥Li₂S full cells at different scan rates. Compared to the control Ni∥Li₂S cell, the Ni∥(Li₂S+0.1Te) cell shows at least one new peak at 2.45 V (cathodic scan) and 2.55 V (anodic scan) corresponding to the reaction of polysulfides with tellurium, demonstrating its unique electrochemistry in the Li—S system.

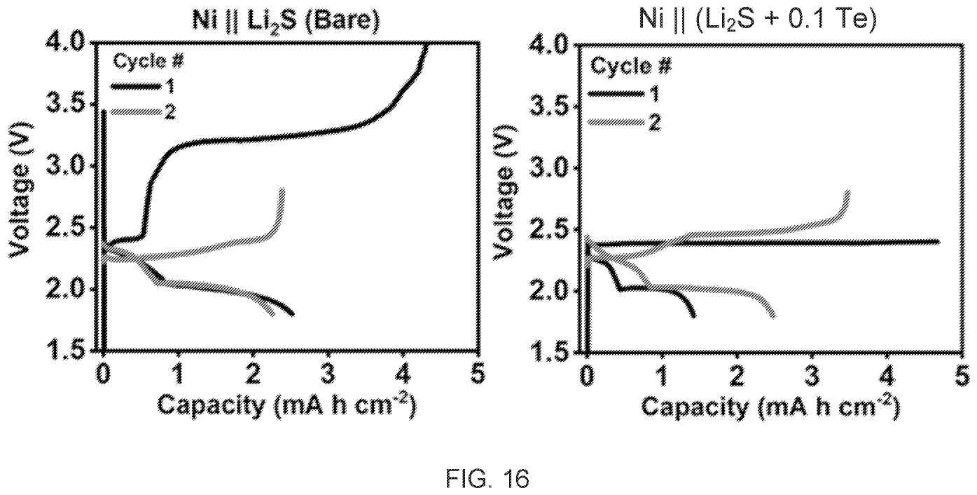

FIG. 16. Charge/discharge profiles of the different anode-free Ni∥Li₂S full cells for the first and second cycles. The first charge step is done at C/20 rate, followed by C/5 for every other step. The Ni∥(Li₂S+0.1Te) cell shows a flat voltage profile at 2.4 V during the first charge step, which had to be terminated with a theoretical capacity limit. The first discharge step also shows much lower capacity. This indicates that there was significant shuttle during the first cycle, presumably due to the formation of polytellurosulfides. However, the cell shows normal charge/discharge profiles during subsequent cycles.

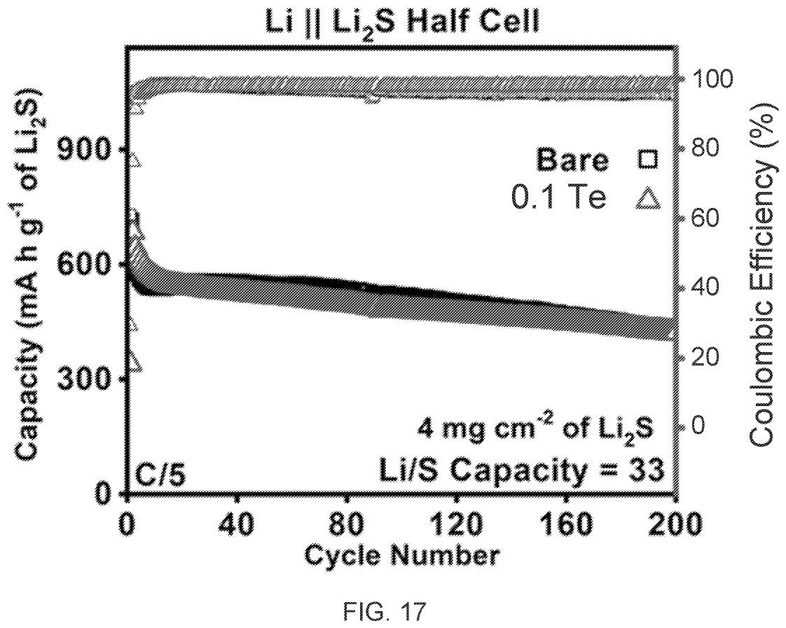

FIG. 17. Capacity vs cycle number for Li∥Li₂S half-cells at C/5 rate. Since there is a large excess of lithium, its performance is entirely reflective of the cathode. In these investigations, Te is simply mechanically mixed with the Li₂S/CNT cathode at room temperature. Te is also electrochemically inactive in the (2.8 V-1.8 V) voltage window. The results show that the addition of 0.1Te makes no difference to the electrochemical performance of Li∥Li₂S half-cells, with nearly identical performance as the control cell without any additive. Thus, it has no impact on the redox kinetics of the Li₂S cathode. Hence, the excellent cyclability of the anode-free Ni∥(Li₂S+0.1Te) full cell can be attributed entirely to the enhanced reversibility of lithium deposition. This also demonstrates how the large excess of lithium and electrolyte in half cells obfuscates the impact of lithium plating/stripping efficiency on electrochemical performance and provides no meaningful information on the dynamic behavior of the lithium-metal anode.

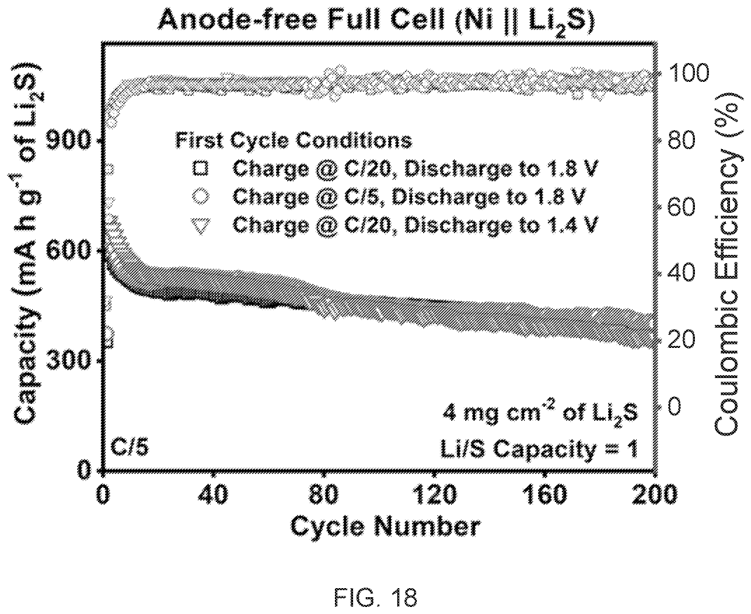

FIG. 18. Effect of initial cycling conditions on the performance of the anode-free Ni∥(Li₂S+0.1Te) full cell. The control testing condition is initial charge at C/20 rate for 20 h, followed by initial discharge at C/5 rate down to 1.8 V. If the initial charge is done at C/5 rate for 5 h, followed by discharge down to 1.8 V at C/5, the electrochemical performance is nearly identical to the control testing condition. If the initial charge is done at C/20 rate for 20 h, followed by discharge down to 1.4 V at C/5, the electrochemical performance is also nearly identical to the control testing condition. The discharge down to 1.4 V is to discharge the tellurium additive, which is electrochemically inactive up to 1.8 V. Thus, the stabilizing effect of tellurium is robust enough to not depend on the initial cycling conditions.

FIGS. 19A-19C. CVs for Li∥Te half-cells with a bare tellurium/CNT cathode (without any Li₂S) in 1 M LiTFSI+0.1 M LiNO₃ in DOL/DME (1:1) electrolyte, and XPS of the lithium surface after two scans each at 0.05 and 0.1 mV s⁻¹. No redox peaks are observed when the Li∥Te cell is scanned between 2.8 and 1.8 V and no tellurium species are found on the Li surface either. This proves the electrochemical inactivity of Te in that voltage range. When scanned between 2.8 and 1.2 V, strong peaks are observed for tellurium oxidation and reduction. Reduced tellurium species are found on the lithium surface as Te⁻¹ or Li₂Te₂, from the formation of soluble lithium polytellurides. However, when 0.1 M Li₂S₆ is added to the electrolyte of the Li∥Te cell and scanned between 2.8 and 1.8 V, a completely different and novel electrochemistry is observed. The standard peaks corresponding to the redox reactions of Li₂S₆ are present. A new peak is observed at 2.45/2.55 V, corresponding to the reaction of tellurium with Li₂S₆, which is the same peak described in FIG. 7D. Another new peak in the cathodic scan between 1.8 and 1.9 V most likely corresponds to the reduction of tellurium, catalyzed by polysulfides to a lower overpotential (or higher discharge voltage). In this case, oxidized tellurium species are found on the lithium surface, as Te+⁴ (—S) or Li₂TeS₃ and Te⁺⁴ (—O) or Li₂TeO₃. These are the same SEI components found on the deposited lithium in the anode-free Ni∥(Li₂S+0.1Te) full cell and originate from the decomposition of polytellurosulfides on the lithium surface. The magnitude of tellurium crossover to the lithium anode is also significantly higher in the presence of polysulfides, proving that the reaction between tellurium and polysulfides to form soluble polytellurosulfides is facile and quite severe.

FIG. 20. Quantification of XPS (Te 3d and S 2p) measurements for the deposited lithium in the anode-free Ni∥(Li₂S+0.1Te) full cell. Peaks for Te⁺⁴ (—S) at 574.5 eV and S⁻²(—Te) at 160.5 eV are the dominant peaks. An atomic ratio for S/Te as 2.98 is obtained. This clearly indicates the presence of TeS₃²⁻ species in the form of lithium thiotellurate (Li₂TeS₃).

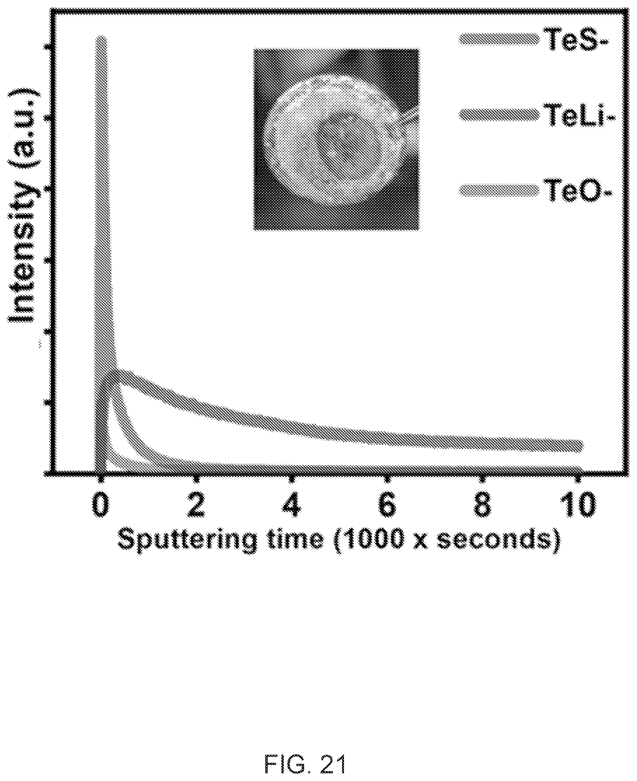

FIG. 21. ToF-SIMS of the deposited lithium in the anode-free Ni∥(Li₂S+0.1Te) full cell shows two different profiles for the TeS⁻ fragment (from Li₂TeS₃) and the LiTe⁻ fragment (from Li₂Te/Li₂Te₂). The TeS⁻ fragment increases initially but then declines quickly, while the LiTe⁻ shows a consistent signal throughout the depth of the deposited lithium. Thus, there is a bilayer structure to the SEI, with Li₂TeS₃ at the top and Li₂Te in the bulk of the deposited lithium. The TeO⁻ fragment, from Li₂TeO₃ is only a minor component and disappears rapidly with increasing depth. Thus, any oxidation of Li₂TeS₃ in the cell is not a critical limiting factor. The optical image inset shows a picture of the deposited lithium in the anode-free Ni∥(Li₂S+0.1Te) full cell. The red colored deposits on top of the lithium comprise Li₂TeS₃, which is a red-colored covalent solid.

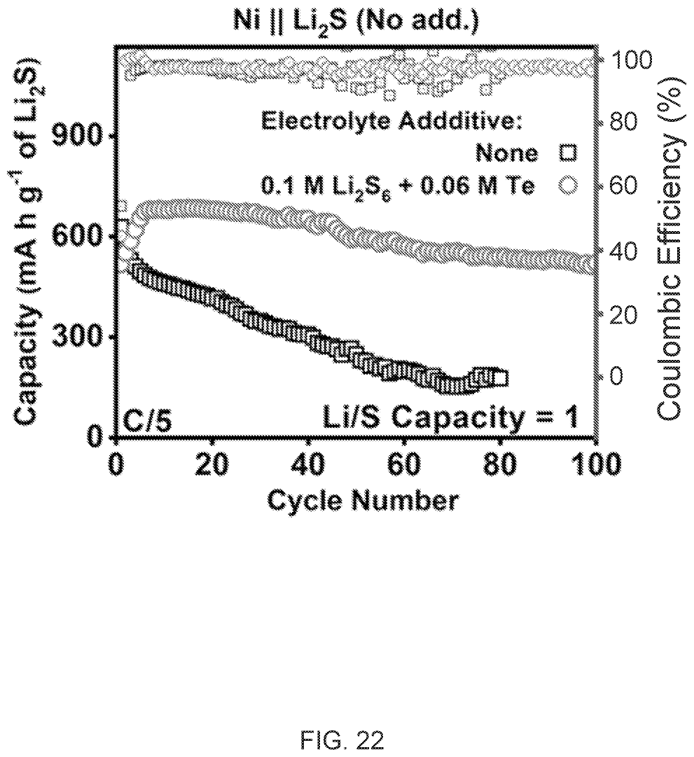

FIG. 22. Capacity vs. cycle number for anode-free Ni∥Li₂S full cell (no cathode additive) with polytellurosulfides generated by completely reacting 0.1 M Li₂S₆ with 0.06 M Te⁰ used as the electrolyte additive. Thus, tellurium is introduced into the system in the electrolyte instead of the cathode. A significant improvement in the capacity retention is observed over the control electrolyte, proving the stabilizing effect of the soluble polytellurosulfides on lithium deposition.

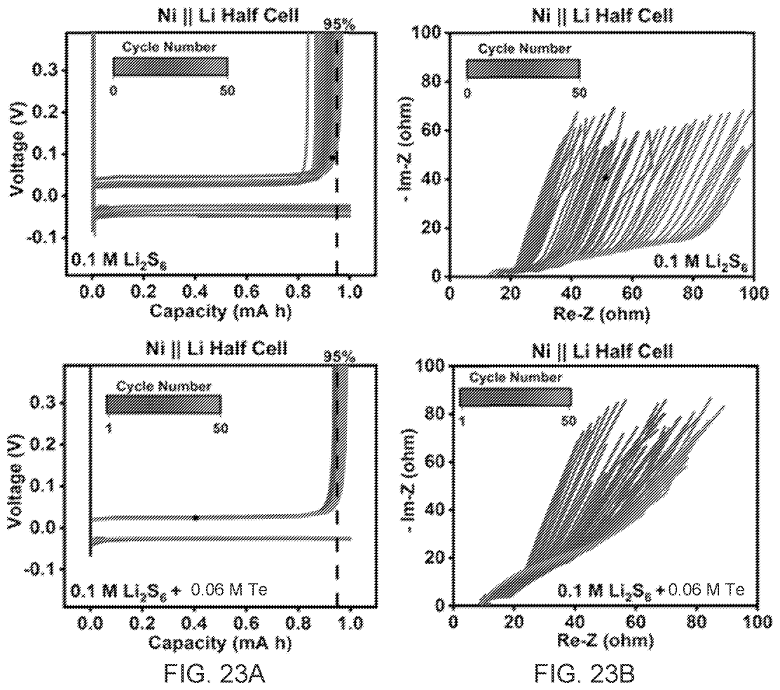

FIG. 23A. Voltage profiles for plating and stripping lithium in Ni∥Li half cells (pairing lithium foil with nickel foil), with two electrolyte additives −0.1 M Li₂S₆ and 0.1 M Li₂S₆ reacted with 0.06 M Te⁰ to create polytellurosulfides. While the bare 0.1 M Li₂S₆ additive shows Coulombic efficiencies averaging 94.1% and overpotentials increase from 49 to 102 mV over 50 cycles, the inclusion of 0.06 M Te⁰ reacted with 0.1 M Li₂S₆ in the electrolyte shows stable overpotentials at 46 mV and higher Coulombic efficiencies of 96.9%. FIG. 23B. Nyquist plot of the impedance spectra for the Nil Li half cells shows a steady increase in the interfacial and charge-transfer resistance (RSEI+RCT) with bare 0.1 M Li₂S₆ additive, which signals the growth of a resistive and thick SEI layer. In the presence of tellurium, only a limited increase in interfacial and charge-transfer resistance is observed, which signals that the SEI layer formed is thin and much less resistive.

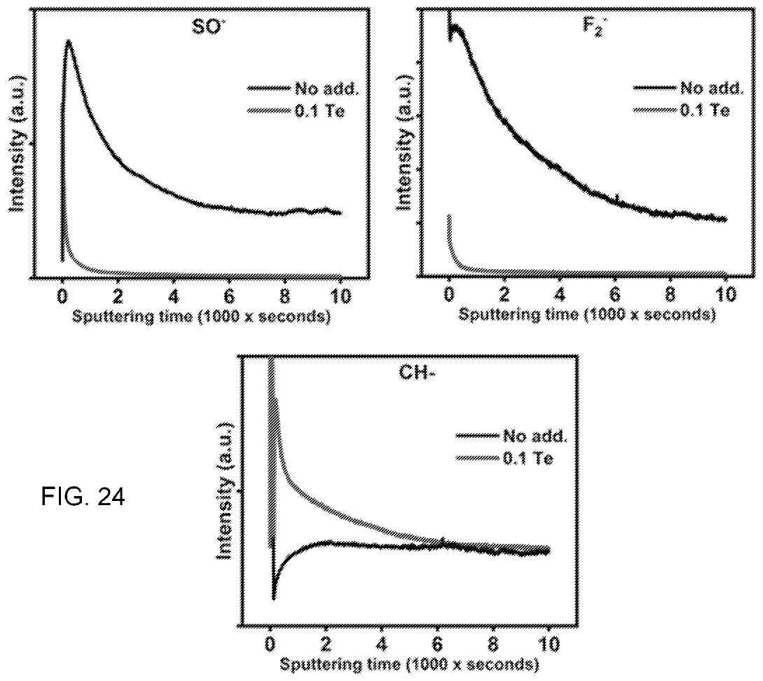

FIG. 24. Depth profiles obtained with ToF-SIMS for the SO⁻, F₂⁻, and CH⁻ fragments in the deposited lithium of the anode-free Nil Li₂S full cells after 30 cycles. The SO⁻ and F₂⁻ fragments originate from electrolyte decomposition. The depth profiles show strong signals for these fragments in the control cell. With the addition of Te, these signals are eliminated from the bulk of the deposited lithium. Thus, tellurium is exceptionally successful in suppressing electrolyte decomposition on the lithium surface. The cell with Te additive shows a strong signal for the CH⁻ fragment for the first 4,000 s of sputtering, while the control cell is highly deficient in the CH⁻ fragment in the same region. The CH⁻ fragment is a marker for the organic components of the SEI, originating as reduction products of the ethereal solvents DOL and DME. These organic components are preserved when lithium deposition is stabilized with Te, while they are replaced with inorganic components due to electrolyte decomposition when lithium deposition exhibits poor reversibility.

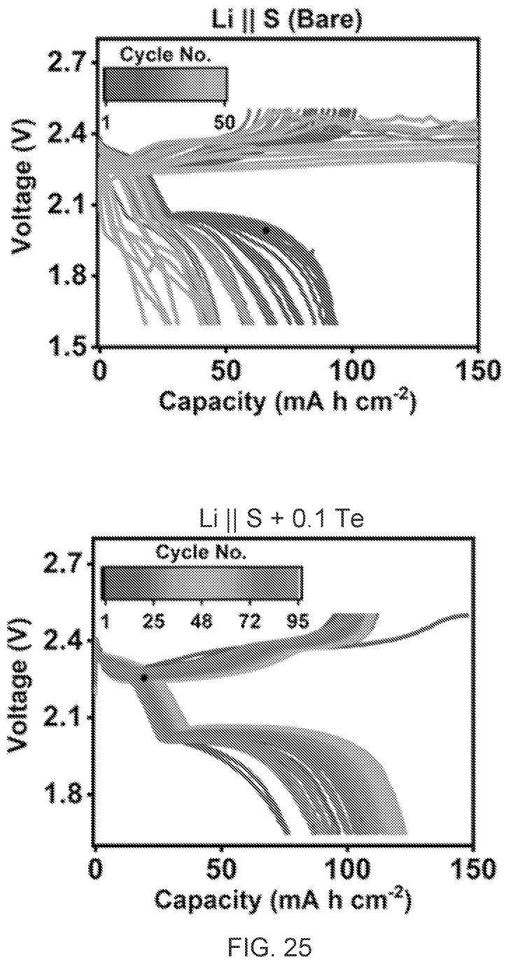

FIG. 25. Charge-discharge profiles for the large-area Li—S(39 cm²) pouch cells, with and without 0.1Te additive, cycled at C/10 rate (0.87 mA cm′). The sulfur loading is 5.2 mg cm⁻² and the E/S ratio is less than 5. The pouch cell without any additive fails rapidly, within 25 cycles. In contrast, the use of Te additive has a dramatic effect on the cyclability of the pouch cell, lasting nearly 100 cycles. The highest capacities and most stable cycling are obtained in the middle, around 50 cycles.

FIG. 26. Capacity versus cycle number for lean-electrolyte Li—S coin cells, with and without 0.1Te additive, cycled at C/5 rate. The sulfur loading is 4 mg cm⁻² and the E/S ratio is 8. As expected, the addition of Te leads to better cyclability and higher Coulombic efficiencies. The motivation for investigating lean-electrolyte coin cells was to analyze the surface of harvested lithium under lean electrolyte conditions while avoiding the safety complications of handling large-area cycled lithium from pouch cells. The XPS data for the lithium surface is discussed in FIG. 10C. However, coin cells are ill-suited for investigating low E/S ratios (<5) due to limitations imposed by their geometry. Pouch cells provide more reliable and repeatable electrochemical performance data under such lean-electrolyte conditions.

### Example 2: Molybdenum-, Tungsten-, and Carbon-Based Interface Materials

The strategies described in this Example provide additional embodiments of artificial SEI layers with the general formula AₓM_{y}Q_{z} for stabilizing lithium deposition.

Taking inspiration from the in situ formation of Li₂TeS₃, ammonium tetrathiomolybdate ((NH₄)₂MoS₄ or ATTM) and ammonium tetrathiotungstate ((NH₄)₂WS₄ or ATTW) were used as cathode additives in the Li—S system to engender the formation of a stabilizing SEI layer on the lithium surface with the general formula LiₓMo_{y}S_{z} and LiₓW_{y}S_{z}, respectively. These additives function in a similar manner to tellurium, by reacting with polysulfides (Li₂Sₙ) to generate soluble thiomolybdate and thiotungstate species, which further reduce on the lithium surface to form LiₓMo_{y}S_{z} and LiₓW_{y}S_{z}. The formation of these Mo and W enriched sulfides as artificial SEI layers can stabilize lithium deposition and enhance lithium cycling efficiency.

Several anode-free Ni∥Li₂S full cells that contain no excess lithium inventory were prepared, including cells with ATTM as a cathode additive, ATTW as a cathode additive, and no cathode additive. These cells were cycled to observe their capacity as a function of cycle number, which is shown in FIG. 27. The cells including ATTM and ATTW as cathode additives exhibit much longer cycle life than the cell including no cathode additive, where capacity drops significantly very quickly.

Another strategy inspired by the in situ formation of Li₂TeS₃ is the in situ formation of lithium trithiocarbonate (Li₂CS₃) on the lithium surface. This can be achieved by the simple substitution of Li₂S with Li₂CS₃ in the cathode of anode-free full cells. The use of Li₂CS₃ as the cathode active material can generate soluble species during cell operation that reduce on the lithium surface to form Li₂CS₃ as an artificial SEI layer. This can helps realize dense, homogenous, and reversible lithium deposition and can significantly extend cycle life in anode-free full cells. Li₂CS₃ can be facilely generated by a simple reaction of Li₂S with carbon disulfide (CS₂).

### Illustrative Aspects

As used below, any reference to multiple aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is an electrode comprising: an alkali metal or a substrate for alkali metal deposition; and an interface material on a surface of the alkali metal or the substrate, the interface material comprising: a metal or combination of metals; a chalcogen or any combination of chalcogens; and one or more elements, one or more organic functional groups, or a combination of one or more elements and one or more organic functional groups.

Aspect 2 is the electrode of any previous or subsequent aspect, wherein the interface material comprises, corresponds to, or acts as an artificial solid-electrolyte interphase.

Aspect 3 is the electrode of any previous or subsequent aspect, wherein the interface material has a chemical formula of AₓM_{y}Q_{z}, wherein A is the metal or combination of metals, wherein Q is the chalcogen or any combination of chalcogens, wherein M is the one or more elements, one or more organic functional groups, or the combination of one or more elements and one or more organic functional groups, wherein x is from 0 to 1, wherein y is from 0 to 1, and wherein z is from 0 to 1.

Aspect 4 is the electrode of any previous or subsequent aspect, wherein the alkali metal is lithium, sodium, potassium, or cesium.

Aspect 5 is the electrode of any previous or subsequent aspect, wherein the chalcogen or combination of chalcogens is one or a combination of sulfur, selenium, or tellurium.

Aspect 6 is the electrode of any previous or subsequent aspect, wherein the metal is an alkali metal.

Aspect 7 is the electrode of any previous or subsequent aspect, wherein the metal is lithium, sodium, potassium, or cesium.

Aspect 8A is the electrode of any previous or subsequent aspect, wherein the one or more elements, the one or more organic functional groups, or the combination of one or more elements and one or more organic functional groups is or comprises an element less electronegative than the chalcogen or the combination of chalcogens.

Aspect 8B is the electrode of any previous or subsequent aspect, wherein the one or more elements, the one or more organic functional groups, or the combination of one or more elements and one or more organic functional groups is or comprises an element having a similar electronegativity to the chalcogen or the combination of chalcogens.

Aspect 9 is the electrode of any previous or subsequent aspect, wherein the one or more elements is one or a combination of tellurium, phosphorus, arsenic, antimony, bismuth, carbon, germanium, tin, lead, gallium, indium, molybdenum, tungsten, titanium, vanadium, copper, silver, gold, zinc, or cadmium.

Aspect 10 is the electrode of any previous or subsequent aspect, comprising a component of a secondary electrochemical cell or a rechargeable battery.

Aspect 11 is the electrode of any previous or subsequent aspect, wherein the interface material comprises Li₂TeS₃, Li₃SbS₄, Li₂CS₃. LiₓMo_{y}S_{z}, or LiₓW_{y}S_{z}, wherein x, y, and z are independently between 0 and 1.

Aspect 12 is an electrochemical cell comprising: a positive electrode that can reversibly store and release alkali-metal ions; an electrolyte; and a negative electrode comprising: an alkali metal or a substrate for alkali metal deposition; and an interface material on a surface of the alkali metal or the substrate, the interface material comprising: a metal or combination of metals; a chalcogen or any combination of chalcogens; and one or more elements, one or more organic functional groups, or a combination of one or more elements and one or more organic functional groups.

Aspect 13 is the electrochemical cell of any previous or subsequent aspect, wherein the positive electrode is a conversion-based or insertion-based cathode.

Aspect 14 is the electrochemical cell of any previous or subsequent aspect, wherein the positive electrode comprises an oxygen-based electroactive material, a sulfur-based electroactive material, a selenium-based electroactive material, a layered-oxide cathode material, LCO, NMC, NCA, a spinel-based cathode material, LMO, LNMO, a polyanion-based cathode material, or LFP.

Aspect 15 is the electrochemical cell of any previous or subsequent aspect, wherein the alkali metal is lithium, sodium, potassium, or cesium.

Aspect 16 is the electrochemical cell of any previous or subsequent aspect, wherein the chalcogen or combination of chalcogens is one or a combination of sulfur, selenium, or tellurium.

Aspect 17 is the electrochemical cell of any previous or subsequent aspect, wherein the metal is an alkali metal.

Aspect 18 is the electrochemical cell of any previous or subsequent aspect, wherein the one or more elements, the one or more organic functional groups, or the combination of one or more elements and one or more organic functional groups is or comprises an element less electronegative than the chalcogen or the combination of chalcogens.

Aspect 19 is the electrochemical cell of any previous or subsequent aspect, wherein the one or more elements is one or a combination of tellurium, phosphorus, arsenic, antimony, bismuth, germanium, tin, lead, gallium, indium, molybdenum, tungsten, titanium, vanadium, copper, silver, gold, zinc, or cadmium.

Aspect 20 is the electrochemical cell of any previous or subsequent aspect, wherein the electrolyte is a solid or liquid or mixed-phase material that conducts alkali-metal ions and blocks passage of electrons.

Aspect 21 is the electrochemical cell of any previous or subsequent aspect, wherein the interface material is fabricated prior to assembly of the electrochemical cell.

Aspect 22 is the electrochemical cell of any previous or subsequent aspect, wherein the interface material is fabricated ex situ prior to assembly of the electrochemical cell using a vapor deposition technique or a solution coating technique.

Aspect 23 is the electrochemical cell of any previous or subsequent aspect, wherein the interface material is formed in situ after assembly of the electrochemical cell.

Aspect 24 is the electrochemical cell of any previous or subsequent aspect, wherein the interface material is formed in situ during operation when an electric field is applied between the positive electrode and the negative electrode.

Aspect 25 is the electrochemical cell of any previous or subsequent aspect, wherein the interface material is formed in situ during one or more charging or discharging operations.

Aspect 26 is the electrochemical cell of any previous or subsequent aspect, comprising a secondary electrochemical cell or a rechargeable battery or a component thereof.

Aspect 27 is the electrochemical cell of any previous or subsequent aspect, wherein the negative electrode comprises the electrode of any of any previous or subsequent aspect.

Aspect 28 is a method of producing an interface material on a negative electrode of an electrochemical cell, the method comprising: introducing an additive into a component of the electrochemical cell during assembly; and forming the interface material in situ after assembly of the electrochemical cell, wherein the interface material comprises: a metal or combination of metals; a chalcogen or any combination of chalcogens; and one or more elements, one or more organic functional groups, or a combination of one or more elements and one or more organic functional groups.

Aspect 29 is the method of any previous or subsequent aspect, wherein the electrochemical cell is based on alkali metal plating and stripping.

Aspect 30 is the method of any previous or subsequent aspect, wherein the additive is introduced into an electrolyte of the electrochemical cell, such as where the additive is optionally a polytellurosulfide, a thiomolybdate species, or a thiotungstate species.

Aspect 31 is the method of any previous or subsequent aspect, wherein the interface material is formed in situ by partial or complete reduction of one or more components of the electrolyte, including the additive, on a surface of the negative electrode.

Aspect 32 is the method of any previous or subsequent aspect, wherein the additive is introduced into a positive electrode of the electrochemical cell, such as where the additive is optionally tellurium, an alkali metal trithiocarbonate (e.g., Li₂CS₃), a thiomolybdate (e.g., ammonium tetrathiomolybdate), or a thiotungstate (e.g., ammonium tetrathiotungstate).

Aspect 33 is the method of any previous or subsequent aspect, wherein the interface material is formed in situ by: reaction of the additive with one or more electrolyte components to form a secondary electrolyte component, and partial or complete reduction of the secondary electrolyte component on a surface of the negative electrode.

Aspect 34 is the method of any previous or subsequent aspect, wherein the additive is introduced onto a polymer separator of the electrochemical cell as a coating.

Aspect 35 is the method of any previous or subsequent aspect, wherein the interface material is formed in situ by: reaction of the coating with one or more electrolyte components to form a secondary electrolyte component; and partial or complete reduction of the secondary electrolyte component on a surface of the negative electrode.

Aspect 36 is the method of any previous or subsequent aspect, wherein the additive is introduced into a negative electrode or negative electrode current collector of the electrochemical cell.

Aspect 37 is the method of any previous or subsequent aspect, wherein the interface material is formed in situ by: reaction of the additive with one or more electrolyte components to form a secondary electrolyte component, and partial or complete reduction of the secondary electrolyte component on a surface of the negative electrode.

Aspect 38 is the method of any previous or subsequent aspect, wherein the interface material is formed in situ by: partial or complete reduction or reaction of the additive on a surface of the negative electrode.

Aspect 39 is the method of any previous or subsequent aspect, wherein the electrochemical cell comprises: a positive electrode comprising a sulfur-based active material and the additive, wherein the additive is tellurium; an organic liquid electrolyte; and the negative electrode, wherein the negative electrode corresponds to a lithium plating and stripping electrode, and wherein the interface material comprises Li₂TeS₃.

Aspect 40 is the method of any previous or subsequent aspect, further comprising: disassembling the electrochemical cell to separate a negative electrode with the interface material thereon; and incorporating the negative electrode with the interface material thereon in another electrochemical cell.

Aspect 41 is the method of any previous or subsequent aspect, wherein the electrochemical cell comprises or corresponds to a secondary electrochemical cell or a rechargeable battery or a component thereof.

Aspect 42 is the method of any previous or subsequent aspect, wherein the electrochemical cell comprises: a positive electrode; an electrolyte; and a negative electrode comprising the electrode of any of any previous or subsequent aspect.

Aspect 43 is the method of any previous or subsequent aspect, wherein the electrochemical cell comprises the electrochemical cell of any of any previous or subsequent aspect.

### REFERENCES

Assegie, A. A., Cheng, J. H., Kuo, L. M., Su, W. N. & Hwang, B. J. Polyethylene oxide film coating enhances lithium cycling efficiency of an anode-free lithium-metal battery. Nanoscale
Assegie, A. A. et al. Multilayer-graphene-stabilized lithium deposition for anode-Free lithium-metal batteries. Nanoscale 11, 2710-2720 (2019).
Babo, J., Wolff, K., & Schleid, T. Two New Cesium Thiotellurates: Cs₂[TeS₂] and Cs₂[TeS₃]. Z. Anorg. Allg. Chem. 639:15, 2875-2881 (2013).
Bai, P., Li, J., Brushett, F. R. & Bazant, M. Z. Transition of lithium growth mechanisms in liquid electrolytes. Energy Environ. Sci. 9, 3221-3229 (2016).
Beyene, T. T. et al. Effects of Concentrated Salt and Resting Protocol on Solid Electrolyte Interface Formation for Improved Cycle Stability of Anode-Free Lithium Metal Batteries. ACS Appl. Mater. Interfaces 11, 31962-31971 (2019).
Beyene, T. T. et al. Concentrated dual-salt electrolyte to stabilize Li metal and increase cycle life of anode free li-metal batteries. J. Electrochem. Soc. 166, A1501-A1509 (2019).
Chen, S. et al. Critical Parameters for Evaluating Coin Cells and Pouch Cells of Rechargeable Li-Metal Batteries. Joule 3, 1094-1105 (2019).
Chen, S. et al. Sulfide solid electrolytes for all-solid-state lithium batteries: Structure, conductivity, stability and application. Energy Storage Materials vol. 14 58-74 (2018).
Cheng, X. B. et al. Sulfurized solid electrolyte interphases with a rapid Li+ diffusion on dendrite-free Li metal anodes. Energy Storage Mater. 10, 199-205 (2018).
Cheng, X. B. et al. The gap between long lifespan Li—S coin and pouch cells: The importance of lithium metal anode protection. Energy Storage Mater. 6, 18-25 (2017).
Cheng, X. B., Huang, J. Q. & Zhang, Q. Review—Li Metal Anode in Working Lithium-Sulfur Batteries. J. Electrochem. Soc. 165, A6058-A6072 (2018).
Chung, S. H. & Manthiram, A. Designing Lithium-Sulfur Cells with Practically Necessary Parameters. Joule 2, 710-724 (2018).
Chung, S. H., Chang, C. H. & Manthiram, A. Progress on the Critical Parameters for Lithium-Sulfur Batteries to be Practically Viable. Adv. Funct. Mater. 28, 1801188 (2018).
Cohn, A. P., Muralidharan, N., Carter, R., Share, K. & Pint, C. L. Anode-Free Sodium Battery through In Situ Plating of Sodium Metal. Nano Lett. 17, 1296-1301 (2017).
Devillanova, F. A. & Du Mont, W.-W. Handbook of chalcogen chemistry: new perspectives in sulfur, selenium and tellurium. (Royal Society of Chemistry, 2013).
Fang, C. et al. Quantifying inactive lithium in lithium metal batteries. Nature 572, 511-515 (2019).
Gao, Z. et al. Promises, Challenges, and Recent Progress of Inorganic Solid-State Electrolytes for All-Solid-State Lithium Batteries. Adv. Mater. 30, 1705702 (2018).
Hagen, M., Fanz, P. & Take, J. Cell energy density and electrolyte/sulfur ratio in Li—S cells. J. Power Sources 264, 30-34 (2014).
Hagos, T. M. et al. Dual electrolyte additives of potassium hexafluorophosphate and tris (trimethylsilyl) phosphite for anode-free lithium metal batteries. Electrochim. Acta 316, 52-59 (2019).
He, J. et al. Three-Dimensional Hierarchical Reduced Graphene Oxide/Tellurium Nanowires: A High-Performance Freestanding Cathode for Li—Te Batteries. ACS Nano 10, 8837-8842 (2016).
Jain, A. et al. Commentary: The materials project: A materials genome approach to accelerating materials innovation. APL Materials vol. 1 (2013).
Kishida, I. et al. First-principles calculations of migration energy of lithium ions in halides and chalcogenides. J. Phys. Chem. B 110, 8258-8262 (2006).
Lang, P. F. & Smith, B. C. Ionic radii for Group 1 and Group 2 halide, hydride, fluoride, oxide, sulfide, selenide and telluride crystals. Dalt. Trans. 39, 7786-7791 (2010).
Lau, J. et al. Sulfide Solid Electrolytes for Lithium Battery Applications. Advanced Energy Materials vol. 8 (2018).
Lee, D. C. & Halliday, A. N. Precise determinations of the isotopic compositions and atomic weights of molybdenum, tellurium, tin and tungsten using ICP magnetic sector multiple collector mass spectrometry. Int. J. Mass Spectrum. Ion Process. 146-147, 35-46 (1995).
Li, W. et al. The synergetic effect of lithium polysulfide and lithium nitrate to prevent lithium dendrite growth. Nat. Commun. 6, 7436 (2015).
Lin, Z., Liu, Z., Fu, W., Dudney, N. J. & Liang, C. Phosphorous Pentasulfide as a Novel Additive for High-Performance Lithium-Sulfur Batteries. Adv. Funct. Mater. 23, 1064-1069 (2013).
Liu, J. et al. Pathways for practical high-energy long-cycling lithium metal batteries. Nature Energy vol. 4 180-186 (2019).
Liu, Y. et al. Lithium-tellurium batteries based on tellurium/porous carbon composite. J. Mater. Chem. A 2, 12201-12207 (2014).
Lochala, J., Liu, D., Wu, B., Robinson, C. & Xiao, J. Research Progress toward the Practical Applications of Lithium—Sulfur Batteries. ACS Appl. Mater. Interfaces 9, 24407-24421 (2017).
Manthiram, A., Chung, S. H. & Zu, C. Lithium-Sulfur Batteries: Progress and Prospects. Adv. Mater. 27, 1980-2006 (2015).
Murphy, L. R., Meek, T. L., Louis Allred, A. & Alien, L. C. Evaluation and test of Pauling's electronegativity scale. J. Phys. Chem. A 104, 5867-5871 (2000).
Nagpure, S. C. et al. Impacts of lean electrolyte on cycle life for rechargeable Li metal batteries. J. Power Sources 407, 53-62 (2018).
Nanda, S., Gupta, A. & Manthiram, A. A Lithium—Sulfur Cell Based on Reversible Lithium Deposition from a Li₂S Cathode Host onto a Hostless-Anode Substrate. Adv. Energy Mater. 8, 25, 1801556 (2018).
Nanda, S., Bhargav, A. & Manthiram, A. Anode-free, Lean Electrolyte Lithium-Sulfur Batteries Enabled by Tellurium-Stabilized Lithium Deposition. Joule, Vol. 4, Issue 5, 1121-1135 (2020).
Neudecker, B. J., Dudney, N. J. & Bates, J. B. ‘Lithium-free’ thin-film battery with in situ plated Li anode. J. Electrochem. Soc. 147, 517-523 (2000).
Pang, Q., Liang, X., Shyamsunder, A. & Nazar, L. F. An In Vivo Formed Solid Electrolyte Surface Layer Enables Stable Plating of Li Metal. Joule 1, 871-886 (2017).
Persson & Kristin. Materials Data on Li₂TeS₃ (SG:14) by Materials Project. (2014) doi:10.17188/1270471.
Persson, K. Materials Data on Li₂Te (SG:225) by Materials Project. (2014) doi:10.17188/1200583.
Qian, J. et al. Anode-Free Rechargeable Lithium Metal Batteries. Adv. Funct. Mater. 26, 7094-7102 (2016).
Wang, Y. et al. Design principles for solid-state lithium superionic conductors. Nat. Mater. 14, 1026-1031 (2015).
Weber, R. et al. Long cycle life and dendrite-free lithium morphology in anode-free lithium pouch cells enabled by a dual-salt liquid electrolyte. Nat. Energy 4, 683-689 (2019).
Xiang, J. et al. Alkali-Metal Anodes: From Lab to Market. Joule, Vol. 3, 2334-2363 (2019).
Xiao, J. How lithium dendrites form in liquid batteries: Studies of interfacial reactions and mass transport may allow safe use of lithium metal anodes. Science vol. 366 426-427 (2019).
Xu, K. et al. Manipulating the Redox Kinetics of Li—S Chemistry by Tellurium Doping for Improved Li—S Batteries. ACS Energy Lett. 3, 420-427 (2018).
Xu, W. et al. Lithium metal anodes for rechargeable batteries. Energy Environ. Sci. 7, 513-537 (2014).
Xu, Z., Chen, R. & Zhu, H. A Li 2 CuPS 4 superionic conductor: A new sulfide-based solid-state electrolyte. J. Mater. Chem. A 7, 12645-12653 (2019).
Yan, C., Zhang, X. Q., Huang, J. Q., Liu, Q. & Zhang, Q. Lithium-Anode Protection in Lithium—Sulfur Batteries. Trends in Chemistry vol. 1 693-704 (2019).
Yu, X. & Manthiram, A. Electrode—electrolyte interfaces in lithium-based batteries. Energy Environ. Sci. 11, 527-543 (2018).
Zhao, C. Z. et al. Li₂S₅-based ternary-salt electrolyte for robust lithium metal anode. Energy Storage Mater. 3, 77-84 (2016).
Zhu, K. et al. How Far Away Are Lithium-Sulfur Batteries From Commercialization? Front. Energy Res. 7, doi:10.3389/fenrg.2019.00123, (2019).

Zhang, S. S., Fan, X. & Wang, C. A tin-plated copper substrate for efficient cycling of lithium metal in an anode-free rechargeable lithium battery. Electrochim. Acta 258, 1201-1207 (2017).

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “‘1’ or ‘2’ or ‘3’ or ‘1 and 2’ or ‘1 and 3’ or ‘2 and 3’ or ‘1, 2 and 3’”.

Every formulation or combination of components described or exemplified can be used to practice the invention, unless otherwise stated. Specific names of materials are intended to be exemplary, as it is known that one of ordinary skill in the art can name the same material differently. It will be appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An electrode comprising:
an alkali metal or a substrate for alkali metal deposition; and
an interface material on a surface of the alkali metal or the substrate,
the interface material comprising:
a metal or combination of metals;
a chalcogen or any combination of chalcogens; and
one or more elements, one or more organic functional groups, or a combination of one or more elements and one or more organic functional groups.

2. The electrode of claim 1, wherein the interface material comprises, corresponds to, or acts as an artificial solid-electrolyte interphase.

3. The electrode of claim 1, wherein the interface material has a chemical formula of AₓM_{y}Q_{z}, wherein A is the metal or combination of metals, wherein Q is the chalcogen or any combination of chalcogens, wherein M is the one or more elements, one or more organic functional groups, or the combination of one or more elements and one or more organic functional groups, wherein x is from 0 to 1, wherein y is from 0 to 1, and wherein z is from 0 to 1.

4. (canceled)

5. The electrode of claim 1, wherein the chalcogen or combination of chalcogens is one or a combination of sulfur, selenium, or tellurium, wherein the metal is an alkali metal, or wherein the one or more elements is one or a combination of tellurium, phosphorus, arsenic, antimony, bismuth, germanium, tin, lead, gallium, indium, molybdenum, tungsten, titanium, vanadium, copper, silver, gold, zinc, or cadmium.

6. (canceled)

7. (canceled)

8. The electrode of claim 1, wherein the one or more elements, the one or more organic functional groups, or the combination of one or more elements and one or more organic functional groups is or comprises an element less electronegative than the chalcogen or the combination of chalcogens.

9. (canceled)

10. (canceled)

11. The electrode of claim 1, wherein the interface material comprises Li₂TeS₃, Li₃SbS₄, Li₂CS₃, LiₓMo_{y}S_{z}, or LiₓW_{y}S_{z}, wherein x, y, and z are independently between 0 and 1.

12. An electrochemical cell comprising:
a positive electrode that can reversibly store and release alkali-metal ions;
an electrolyte; and
a negative electrode comprising:
an alkali metal or a substrate for alkali metal deposition; and
an interface material on a surface of the alkali metal or the substrate,
the interface material comprising:
a metal or combination of metals;
a chalcogen or any combination of chalcogens; and
one or more elements, one or more organic functional groups, or a combination of one or more elements and one or more organic functional groups.

13. The electrochemical cell of claim 12, wherein the positive electrode is a conversion-based or insertion-based cathode or wherein the positive electrode comprises an oxygen-based electroactive material, a sulfur-based electroactive material, a selenium-based electroactive material, a layered-oxide cathode material, LCO, NMC, NCA, a spinel-based cathode material, LMO, LNMO, a polyanion-based cathode material, or LFP.

14. (canceled)

15. (canceled)

16. The electrochemical cell of claim 12, wherein the chalcogen or combination of chalcogens is one or a combination of sulfur, selenium, or tellurium, wherein the metal is an alkali metal, or wherein the one or more elements is one or a combination of tellurium, phosphorus, arsenic, antimony, bismuth, germanium, tin, lead, gallium, indium, molybdenum, tungsten, titanium, vanadium, copper, silver, gold, zinc, or cadmium.

17. (canceled)

18. The electrochemical cell of claim 12, wherein the one or more elements, the one or more organic functional groups, or the combination of one or more elements and one or more organic functional groups is or comprises an element less electronegative than the chalcogen or the combination of chalcogens.

19. (canceled)

20. (canceled)

21. (canceled)

22. (canceled)

23. (canceled)

24. (canceled)

25. (canceled)

26. (canceled)

27. (canceled)

28. A method of producing an interface material on a negative electrode of an electrochemical cell, the method comprising:
introducing an additive into a component of the electrochemical cell during assembly; and
forming the interface material in situ after assembly of the electrochemical cell,
wherein the interface material comprises:
a metal or combination of metals;
a chalcogen or any combination of chalcogens; and
one or more elements, one or more organic functional groups, or a combination of one or more elements and one or more organic functional groups.

29. (canceled)

30. The method of claim 28, wherein the additive is introduced into an electrolyte of the electrochemical cell, wherein the additive is introduced into a positive electrode of the electrochemical cell, wherein the additive is introduced onto a polymer separator of the electrochemical cell as a coating, or wherein the additive is introduced into a negative electrode or negative electrode current collector of the electrochemical cell.

31. The method of claim 30, wherein the interface material is formed in situ by partial or complete reduction of one or more components of the electrolyte, including the additive, on a surface of the negative electrode.

32. (canceled)

33. The method of claim 30, wherein the additive is one or more of Te, Li₂CS₃, (NH₄)₂MoS₄, or (NH₄)₂WS₄.

34. The method of claim 30, wherein the interface material is formed in situ by:
reaction of the additive with one or more electrolyte components to form a secondary electrolyte component, and
partial or complete reduction of the secondary electrolyte component on a surface of the negative electrode.

35. (canceled)

36. The method of claim 30, wherein the interface material is formed in situ by:
reaction of the coating with one or more electrolyte components to form a secondary electrolyte component; and
partial or complete reduction of the secondary electrolyte component on a surface of the negative electrode.

37. (canceled)

38. The method of claim 30, wherein the interface material is formed in situ by:
reaction of the additive with one or more electrolyte components to form a secondary electrolyte component, and
partial or complete reduction of the secondary electrolyte component on a surface of the negative electrode.

39. The method of claim 30, wherein the interface material is formed in situ by:
partial or complete reduction or reaction of the additive on a surface of the negative electrode.

40. The method of claim 30, wherein the electrochemical cell comprises:
a positive electrode comprising a sulfur-based active material and the additive, wherein the additive is tellurium;
an organic liquid electrolyte; and
the negative electrode, wherein the negative electrode corresponds to a lithium plating and stripping electrode, and wherein the interface material comprises Li₂TeS₃.

41. The method of claim 28, further comprising:
disassembling the electrochemical cell to separate a negative electrode with the interface material thereon; and
incorporating the negative electrode with the interface material thereon in another electrochemical cell.

42. (canceled)

43. (canceled)

44. (canceled)
